(19) United States
(12) Patent Application Publication
(10) Pub. No.: US 2014/0325550 A1
(43) Pub. Date: Oct. 30, 2014

(54) REAL-TIME ANTI-PIRACY FOR BROADCAST STREAMS

(71) Applicant: Verance Corporation, San Diego, CA (US)

(72) Inventors: Joseph M. Winograd, San Diego, CA (US); Rade Petrovic, San Diego, CA (US); Jian Zhao, San Diego, CA (US)

(73) Assignee: Verance Corporation, San Diego, CA (US)

(21) Appl. No.: 14/262,000

(22) Filed: Apr. 25, 2014

Related U.S. Application Data
(60) Provisional application No. 61/838,756, filed on Jun. 24, 2013.
(60) Provisional application No. 61/815,960, filed on Apr. 25, 2013.

(51) Int. Cl. H04N 21/442; H04N 21/8358; H04N 21/258; H04N 21/44

(52) U.S. Cl. CPC H04N 21/44236; H04N 21/44008; H04N 21/8358; H04N 21/2585
USPC 725/19

(57) ABSTRACT

Systems, devices, methods and computer program products respond to real-time piracy of broadcast streams. One method includes receiving requests from a requesting device for a plurality segments of a real-time content, where at least one of the requested content segments differs from another segment of the plurality of segments in at least one characteristic. In response to the request, a particular version of the requested segments is transmitted to the requesting device such that a unique sequence of the transmitted segments identifies the requesting device or a user or a transaction. A communication network is then monitored to obtain a disseminated version of the real-time content, and based on the at least one characteristic of the obtained real-time content, it is determined if the real-time content includes the unique sequence of segments, and if so, one or more actions are initiated to thwart further dissemination of the real-time content.

### CROSS REFERENCE TO RELATED APPLICATIONS

This patent application claims the benefit of U.S. Provisional Patent Application No. 61/815,960, filed Apr. 25, 2013 and U.S. Provisional Patent Application No. 61/838,756, filed Jun. 24, 2013. The entire contents of the before-mentioned provisional patent applications are incorporated by reference as part of the disclosure of this application.

### FIELD OF INVENTION

The present application generally relates to multimedia content management, and more specifically to methods, devices and computer program products to thwart unauthorized usage of multimedia content.

### BACKGROUND

A multimedia content, such as an audiovisual content, often consists of a series of related images which, when shown in succession, impart an impression of motion, together with accompanying sounds, if any. Such a content can be accessed from various sources including local storage such as hard drives or optical disks, remote storage such as Internet sites or cable/satellite distribution servers, over-the-air broadcast channels, etc. In some scenarios, such a multimedia content, or portions thereof, may contain only one type of content, including, but not limited to, a still image, a video sequence and an audio clip, while in other scenarios, the multimedia content, or portions thereof, may contain two or more types of content.

Watermarking has been used to enable the communication and enactment of use policies for multimedia content across a broad range of distribution channels and devices. Watermarks are typically embedded substantially imperceptibly in one or more components of a multimedia content, such as in an audio component or a video component, and can be used for a variety of applications such as tamper detection, copy management, content identification, broadcast monitoring, etc.

### SUMMARY OF SELECT EMBODIMENTS

The disclosed embodiments relate to systems, devices, methods and computer program products that employ a forensic watermark to respond to real-time piracy of broadcast streams delivered to authenticated viewers. One aspect of the disclosed embodiments relates to a method for thwarting unauthorized access to a content that includes receiving a content in real-time at a receiver device authorized to receive the real-time content, and embedding one or more forensic marks in the real-time content that is being received. The one or more forensic marks associate the received real-time content to the receiver device or to a user of the receiver device. The method further includes monitoring a communication network to obtain a disseminated version of the real-time content while the real-time content is still being provided to the receiver device, and determining whether or not the disseminated version of the real-time content includes the one or more forensic marks. Upon a determination that the real-time content includes the one or more forensic marks, one or more actions to thwart further dissemination of the real-time content are initiated.

In one exemplary embodiment, the receiver device corresponds to an authenticated viewer of the real-time content. In another exemplary embodiment, the authenticated viewer is authenticated based on a credential provided to an authorized distributor of the real-time content. In yet another exemplary embodiment, the real-time content is received at the receiver through one or more of: a broadcast channel, a multi-cast channel, or a uni-cast channel. In still another exemplary embodiment, associating the real-time content to the receiver device or a user of the receiver device enables identifying one or more of the following: an authorized user of the receiver device, an account authorized to receive the real-time content, a person authorized to view the real-time content, a transaction to obtain the real-time content, or a device authorized to receive the real-time content.

According to one exemplary embodiment, associating the real-time content to the receiver device or a user of the receiver device comprises embedding a random or pseudo-random number into the received real-time content to uniquely bind the received real-time content to the receiver device or to the user of the receiver device without divulging an identity of the receiver device or the user of the receiver device. In another exemplary embodiment, the one or more forensic marks are further associated with one or more of the following: an identity of the real-time content, an authorized distributor of the real-time content, or an identity of a type of client that is part of, or is being executed, by the receiver device. In still another exemplary embodiment, the one or more forensic marks comprise watermarks that are substantially imperceptible and are embedded into one or more components of the real-time content. For example, the one or more components comprise an audio component or a video component.

In one exemplary embodiment, initiating one or more actions comprises restricting access to the real-time content. In another exemplary embodiment, initiating one or more actions comprises one or more of the following: ceasing to distribute an encryption key to the receiver device, issuing a revocation message to the receiver device, terminating an authentication communication session that enables the receiver device to receive the real-time content, revoking a credential associated with the receiver device or the user of the receiver device, modifying an account status of the receiver device or the user the receiver device, redirecting the communication session that enables the receiver device to receive the real-time content, or modifying the real-time content received by the receiver device. In still another exemplary embodiment, initiating one or more actions comprises one or more of the following: modifying or augmenting the real-time content to include information as to how to obtain the real-time content in an authorized fashion, providing advertisements to the receiver device, providing warnings associated with unauthorized access to the receiver, muting at least a portion of the real-time content's audio component, blanking at least a portion of the real-time content's video component, scrambling at least a portion of the real-time content, or substituting another content in place of the real-time content.

In another exemplary embodiment, initiating one or more actions includes initiating a first action aimed at thwarting unauthorized access to the real-time content, determining whether or not unauthorized dissemination of the real-time content persists, and upon a determination that unauthorized dissemination of the real-time content persists, initiating a second action aimed at thwarting unauthorized access to the real-time content. In one particular embodiment, the first action includes transmission of information to the receiver device indicating that unauthorized access to the real-time content is taking place, and the second action ceases the receiver device's access to the real-time content.

In yet another exemplary embodiment, prior to initiating the one or more actions, the method includes determining whether or not initiating the one or more actions to thwart further dissemination of the real-time content is justified, and only upon a determination that initiating the one or more actions is justified, initiating the one or more actions. In one particular embodiment, the determination as to whether or not the one or more actions is justified is based on one or more of the following: whether or not the real-time content continues to be transmitted to the receiver device, a remaining length of the real-time content that still remains to be broadcast, how much time has lapsed since the receiver device received a full duration of the real-time content, an uncertainty associated with detection of the one or more forensic marks, an uncertainty associated with identification of the receiver device or a user of the receiver device, or whether or not the one or more forensic marks can be authenticated.

According to another exemplary embodiment, the real-time content comprises one or more additional watermark, where the one or more additional watermarks enable identification of the real-time content. In one exemplary embodiment, the above noted method also includes, upon obtaining the disseminated version of the real-time content, detecting the one or more additional watermarks, and identifying the real-time content using the detected one or more additional watermarks. Upon a determination that the real-time content is likely to comprise the one or more forensic marks, the method includes detecting the one or more forensic marks as part of the determination as to whether or at the real-time content includes the one or more forensic marks.

In another exemplary embodiment, embedding of the one or more forensic marks occurs at a entity outside of the receiver device that is coupled to a distribution channel of the real-time content. In yet another exemplary embodiment, the one or more forensic marks are embedded at a trusted entity within a distribution chain of the real-time content. In still another exemplary embodiment, the one or more forensic marks are embedded at the receiver device as the real-time content is being received.

Another aspect of the disclosed embodiments relates to a computer program product, embodied on one or more non-transitory computer readable media, that includes program code for receiving a content in real-time at receiver device authorized to receive the real-time content, and program code for embedding one or more forensic marks in the real-time content that is being received. The one or more forensic marks associate the received real-time content to the receiver device or to a user of the receiver device. The computer program product also includes program code for monitoring a communication network to obtain a disseminated version of the real-time content while the real-time content is still being provided to the receiver device, program code for determining whether or not the disseminated version of the real-time content includes the one or more forensic marks, and program code for, upon a determination that the real-time content includes the one or more forensic marks, initiating one or more actions to thwart further dissemination of the real-time content.

Another aspect of the disclosed embodiments relates to a device that includes at least one processor and a memory comprising processor executable code. The processor executable code when processed by the at least one processor configures the device to monitor a communication network to obtain a real-time content, and determine whether or not the real-time content includes the one or more forensic marks, the one or more forensic marks having been embedded into the real-time content as the real-time content is being received at a receiver device authorized to receive the real-time content. The one or more forensic marks associate the real-time content to the receiver or a user of the receiver device. The processor executable code when processed by the at least one processor configures the device to, upon a determination that the real-time content includes the one or more forensic marks, initiate one or more actions to thwart further dissemination of the real-time content.

Another aspect of the disclosed embodiments relates to a computer program product, embodied on one or more non-transitory computer readable media, that includes program code for monitoring a communication network to obtain a real-time content, and program code for determining whether or not the real-time content includes the one or more forensic marks, the one or more forensic marks having been embedded into the real-time content as the real-time content being received at a receiver device authorized to receive the real-time content. The one or more forensic marks associate the real-time content to the receiver or a user of the receiver device. The computer program product also includes program code for, upon a determination that the real-time content includes the one or more forensic marks, initiating one or more actions to thwart further dissemination of the real-time content.

Another aspect of the disclosed embodiments relates to a method for thwarting unauthorized access to a content that includes monitoring a communication network to obtain a real-time content, determining whether or not the real-time content includes the one or more forensic marks, the one or more forensic marks having been embedded into the real-time content as the real-time content was being received at a receiver device authorized to receive the real-time content. The one or more forensic marks associate the real-time content to the receiver or to a user of the receiver device. The method also includes, upon a determination that the real-time content includes the one or more forensic marks, initiating one or more actions to thwart further dissemination of the real-time content.

Another aspect of the disclosed embodiments relates a device that includes a communication network monitoring device coupled to a communication network to monitor the communication network and to obtain a real-time content from the communication network. The device also includes a watermark detector coupled to the communication network monitoring device to determine whether or not the real-time content includes the one or more forensic marks, where the one or more forensic marks having been embedded into the real-time content as the real-time content was being received by a user device authorized to receive the real-time content. The one or more forensic marks associate the real-time content to the user device or a user of the user device. The device additionally includes a decision logic component coupled to the watermark detector to, upon a determination that the real-time content includes the one or more forensic marks, initiate one or more actions to thwart further dissemination of the real-time content by the user device.

In one exemplary embodiment, the above noted device further includes a processor configured to transmit a credential to an authorized distributor of the real-time content to establish authenticity of the user device or the user device of the user device based on the credential. In another exemplary embodiment, the decision logic component is configured to initiate a first action aimed at thwarting unauthorized access to the real-time content, the device further includes further comprising a processor configured to determine whether or not unauthorized dissemination of the real-time content persists, and upon a determination that unauthorized dissemination of the real-time content persists, the decision logic component is further configured to initiate a second action aimed at thwarting unauthorized access to the real-time content. In one particular embodiment, the first action includes the transmission of information to the receiver device indicating that unauthorized access to the real-time content is taking place, and the second action ceases the receiver device's access to the real-time content.

In another exemplary embodiment, the above device also includes a processor configured to, prior to initiating the one or more actions, determine whether or not initiating the one or more actions to thwart further dissemination of the real-time content is justified, and only upon a determination that initiation of the one or more actions is justified, enable initiation of the one or more actions. In still another exemplary embodiment, the watermark detector is further configured to detect the one or more additional identification watermarks from the real-time content, the device further include a processor configured to identify the real-time content using the detected one or more additional watermarks, and upon a determination that the real-time content is likely to comprise the one or more forensic marks, allow the watermark detector to detect the one or more forensic marks.

Another aspect of the disclosed embodiments relates to a system that includes a receiver to receive a content in real-time at a user device that is authorized to receive the real-time content and an embedder to embed one or more forensic marks in the received real-time content, where the one or more forensic marks associate the received real-time content to the user device or a user of the user device. The system also includes a communication network monitoring device coupled to a communication network to obtain a disseminated version of the real-time content from the communication network while the real-time content is still being provided to the user device, and a watermark detector coupled to the communication network monitoring device to determine whether or not the disseminated version of the real-time content includes the one or more forensic marks. The system additionally includes a decision logic component coupled to the watermark detector to, upon a determination that the real-time content includes the one or more forensic marks, initiate one or more actions to thwart further dissemination of the real-time content by the user device.

In one exemplary embodiment, the user device is part of one or more of the following a cable set-top box, a television, a satellite set-top box, a mobile phone, a tablet, a laptop computer, a personal computer, or an electronic device that is communicatively coupled to a viewing monitor and/or a speaker system. In another exemplary embodiment, the communication network monitoring device, the watermark detector and the decision logic component are part of a single device that is separate from the receiver device. In still another exemplary embodiment, the above noted system also includes a real-time content distributor coupled to the receiver device to deliver the real-time content to the receiver device. In yet another exemplary embodiment, the real-time content distributor is coupled to one of a broadcast channel, a uni-cast channel or a multicast channel to effect delivery of the real-time content.

### BRIEF DESCRIPTION OF THE DRAWINGS

FIG. 1 illustrates a set of operations that can be carried out to thwart unauthorized access to a real-time content in accordance with an exemplary embodiment.

FIG. 2 illustrates a set of operations that can be carried out to thwart unauthorized access to a real-time content in accordance with an exemplary embodiment.

FIG. 3 illustrates a system in accordance with an exemplary embodiment within which various devices and methods for thwarting unauthorized dissemination of real-time content can be implemented.

FIG. 4 illustrates a device that is operable to thwart unauthorized dissemination of real-time content in accordance with an exemplary embodiment.

FIG. 5 illustrates a set of operations that may be carried out to thwart unauthorized access to a real-time content in accordance with another exemplary embodiment.

FIG. 6 illustrates a set of exemplary operations that may be carried out to receive a real-time content that allows subsequent actions to thwart unauthorized access to the real-time content.

FIG. 7 illustrates a block diagram of a device within which various disclosed embodiments may be implemented.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

Live events, such as sport or entertainment events are often broadcast to a subset of customers, such as paying customers in pay-per-view case or subscribers to premium channels of cable or satellite broadcasts. Sometimes broadcast is prevented in an area close to the event venue in order to increase attendance. Often some users capture live broadcasts and stream them over Internet with little delays, making them piracy originators. Then non-subscribers can receive this content for free, or a at a very low cost, typically through some Internet streaming sites. This limits the need for piracy users to pay to watch broadcasts or attend the events. Therefore it is desirable to design a system that would in real-time detect such streaming and enforce copyright protection.

Such live events, which are sometimes referred to as “broadcast streams,” can contain audio or audiovisual content. The term “broadcast” can be used in the context of audio or audiovisual content that is distributed simultaneously (or nearly simultaneously) to viewers at remote locations. However, the term “broadcast” does not constrain or limit the underlying distribution technologies employed, which may be “broadcast” in the technical sense of a single transmission of the content delivered to multiple locations but may also be “multicast” in the technical sense of multiple separate transmissions (which may or may not be identical) of the content to each of the multiple locations. Thus, a live, or real-time, content can be received at a receiver through one or more of a broadcast channel, a multi-cast channel, or a uni-cast channel.

An authenticated viewer is an intended recipient of the broadcast streams. While the term “authenticate viewer” in the singular may be used in the disclosed embodiments, an authenticated viewer could represent more than a single individual; e.g. it could be a group of individuals, such as a family or apartment complex or a public or private location where there may be any of a variety of individuals such as a bar, stadium, theater, kiosk, airport location, etc. The term “authenticated” can be used to convey that the viewer's access to the broadcast stream is based on a credential that is provided to the authorized distributor of the broadcast stream (or, more specifically, a device under the control of the authorized distributor) which is individualized to the specific authenticated viewer and identifies the viewer (or a device that the user possesses). Examples of credentials that are widely used to authenticate viewers include smart cards, account login credentials (e.g. username/password pairs), biometric data, machine-readable device serial numbers, and device keys.

Real-time piracy of broadcast streams occurs when a recipient of the stream retransmits it to other recipients without permission from the owner or rights-holder to the content while the broadcast is occurring. It is of particular concern for events whose contents or outcome is unknown in advance, such as sporting events, competitions, elections, speeches, and breaking news. For many such broadcasts, the commercial value of the content is substantially diminished once the contents or outcome of the event is known. An illustrative example is the Ultimate Fighting Championship (UFC) events which are athletic competitions distributed on a pay-per-view basis in the U.S. and other countries. Broadcast streams of their events, which are held several times per year, are sold in the U.S. for approximately $45 per household, whereas pre-recorded streams of prior events are sold for $1 per household such pre-recorded streams can become available for purchase as early as the day after the event. Real-time piracy of live broadcast streams, such as the live UFC broadcast events, is therefore of substantially greater harm than piracy that occurs after the event has concluded and the outcome is publicly known. Methods and systems that can stop or thwart real-time piracy would be of substantial benefit to the UFC, as it would to other businesses that profit from the production, sale, or distribution of broadcast streams. In most circumstances, such broadcast streams correspond to “live” events, which are being captured and broadcast in more-or-less real-time (setting aside any distribution or broadcast delays) and such thwarting piracy under such circumstances is one focus of the disclosed embodiments. However, there are circumstances where the disclosed embodiments can be applied to stop or thwart piracy of pre-recorded events that is occurring in real-time with respect to its broadcast (such as the premiere of a pre-recorded broadcast television special, season finale, or award show).

Broadcast Stream Piracy

Real-time piracy is effectuated through a variety of different ways. In general, an authenticated viewer (e.g., the “piracy originator”) provides the broadcast stream which the authenticated viewer is receiving (e.g., the “pirate stream”) to a distribution service (e.g., the “pirate distributor”) for access by other viewers (e.g., the “pirate viewers”).

Typically, the piracy originator accesses the broadcast signal which is output from its receiving device. The receiving device can be in a consumer device such as a so-called “set-top box”, a cable-ready television set, a mobile device (such as a smartphone or a tablet, a cable-ready game console), or a personal computer. The receiving device provides or includes components or modules by which the viewer is authenticated to the legitimate distributor. The broadcast signal may be accessed from an analog or digital audio or video connector (or via a wireless connection) by which the receiving device is connected to other audio or audiovisual components in the home (e.g., for display or reproduction). Alternately, or additionally, the broadcast signal may be captured via a microphone and/or a camcorder that records the audio and/or video portion of the broadcast signal from a display, projector, or speaker system. Alternately, or additionally, the piracy originator may use a circumvention device or technique such as a “stream ripper” or signal decrypter to access the broadcast stream in a manner that might otherwise be inaccessible.

Once the signal is accessed, it is must be captured and transmitted to a pirate distributor. Typically, this is performed by feeding the accessed signal into a Personal Computer with audio or audiovisual capture capabilities, where it may be processed (such as via data-rate compression, color correction, dynamic range compression, equalization, or other techniques) and transmitted to the pirate distributor via the Internet. In some cases, such as when the operator of a web portal for pirated stream sources their own broadcast streams, the piracy originator may also be the pirate distributor. In some cases, such as in the case of distributed peer-to-peer lire distribution protocols such as BitTorrent Live, the pirate distributor may also be a pirate viewer.

Watermark Technology

The disclosed embodiments employ watermark data (e.g., a forensic watermark) that is embedded into the audio and/or video portion of the broadcast streams. The term “forensic” is used in the sense that it is individualized to specific authenticated viewers. The term “watermark” is used to describe an information-bearing addition or modification to the content whose presence can subsequently be detected. The watermark is typically hidden and sufficiently secure such that it will be difficult, costly, time-consuming, or damaging to the broadcast content for a pirate to remove or obscure, whether from a single instance of the forensically watermarked broadcast stream or from a combination of multiple instances of forensically watermarked broadcast streams. Typically, the watermark is also sufficiently perceptually transparent that it does not interfere with the authenticated viewers' understanding and/or enjoyment of the broadcast stream. For example, the watermark is imperceptible to viewers under normal viewing conditions. The watermark is typically sufficiently robust so as to remain readable even after the content has been subjected to modifications that occur during distribution of the content to the authenticated viewer, stream capture by the pirate, or distribution to the pirate viewer. Such modifications may include: one or more stages of lossy data encoding, equalization, color correction, presentation on a screen or speakers, camcording or microphone recording, dynamic range and other types of data compression, time or spatial scaling, rotation, pitch correction, or other types of processing. The embedded watermark has a low likelihood of false detection (detection of the mark in unmarked content) or erroneous detection (detection of a mark different from the one embedded in marked content). Further, the watermark is designed in a manner that is resistant to modification or forgery.

In some embodiments, the watermark can be embedded in an automated fashion into a broadcast stream in real-time with a low throughput latency during its distribution to authenticated viewers. Any of a variety of watermark embedding arrangements may be employed, or in some cases a multiplicity of watermarking embedding arrangements may be employed together, where each is adapted to a particular way by which the broadcast stream is distributed to a subset of authenticated viewers. In some arrangements, a multi-stage watermark embedding may be employed where the broadcast stream is analyzed or modified in a first stage of watermark processing to produce side information that is subsequently used in a later stage of watermark processing to complete the watermark embedding in the content.

The watermark can be detected using a blind detection scheme (meaning without access to the original unwatermarked content or side-information derived from the original unwatermarked content) or using a semi-blind scheme (meaning without access to the original unwatermarked signal but with access to information derived from the original unwatermarked content) from the pirated content. In some disclosed embodiments, the watermark can be detected from a short portion of the pirated content. This way, subsequent actions (e.g., anti-piracy) measures can be undertaken quickly, if needed. Detection of watermarks can include analyzing the content to determine the presence and value of watermark data (if any) embedded therein.

Real-Time Anti-Piracy System

To respond to piracy in real-time, an arrangement is employed where broadcast streams delivered to authenticated viewers are embedded with a forensic watermark associated with the viewer, one or more pirated streams derived from those broadcasts is accessed, one or more forensic watermarks are detected from the pirated streams, and one or more actions based on the forensic watermark are initiated.

At least some of these steps may be performed manually by one or more anti-piracy system operators, performed by said operators with the assistance of one or more hardware devices and/or computer programs capable of automating portions of the steps, or be performed in their entirety on an automated basis by a computer program operating on a hardware device. Additionally, certain of the steps may be carried out by different system operators, computer programs, or hardware devices operating in a coordinated fashion in order to achieve the desired result.

It may be necessary to carry out any of these steps multiple times in a parallel or serial fashion in order to respond to multiple simultaneous individual instances of piracy or of authenticated viewers who are making broadcast streams which they receive available for piracy. In so doing, as described herein, it becomes possible to substantially reduce, or even completely eliminate, the public availability of pirated broadcast streams to would-be pirate viewers and provide effective protection of the business interests of legitimate content producers and distributors.

Embedding Forensic Watermarks

The forensic watermark may be embedded in the broadcast streams in any of a number of ways.

In some cases, watermark embedding may occur within a client device possessed by the viewer, such as a set-top box, television, tablet, mobile phone, personal computer, digital media adapter. In other cases, watermark embedding may occur within a device possessed by the authorized distributor (or one of its partners or vendors) such as a centralized server or edge server.

The manner in which the broadcast stream is delivered to authenticated viewers may influence a particular mode of watermark embedding. For example, in some cases, such as satellite broadcast, a single broadcast stream distributed to a large number of receivers may be the primary (or the only) signal communication path from the authorized distributor to the authenticated viewers. In this environment, the broadcast signal is the same for all viewers and the forensic watermark must be embedded into the broadcast stream in the client device. In other cases, such as with Internet Protocol (IP) video delivery to legacy client devices (e.g. those which may not be capable of performing forensic watermark embedding functions), the broadcast stream may be individually delivered to each authorized viewer's client device from a server under the control of an authorized distributor and the forensic watermark processing may necessarily be performed in the server environment.

The client may generate the forensic watermark locally, or it may be generated based wholly or in-part on information provided in the broadcast stream. For example, digital broadcast stream transmission media are capable of carrying both the broadcast stream program content itself (e.g. audio or audiovisual content) as well as associated non-program data, such as security messages, programming guide information, and purchase transaction authorizations. The non-program data may include a message instructing a client device to activate forensic watermark embedding of a program stream. In some embodiments, the non-program data may include a message instructing a client device to embed particular forensic watermark data in a program stream. In some embodiments, the broadcast stream may include multiple alternate versions of the program stream (or portions of the program stream) from which the client device constructs a forensically watermarked program stream. In still other embodiments, the broadcast stream may include non-program data that represents instructions to the client for modifying the program stream to effectuate a particular forensic watermarking of the program stream. Any or all of these approaches are within the scope of the present disclosure. For example, the techniques described in any one or U.S. Pat. Nos. 8,020,004, 6,912,315 and 7,644,282, which are herein incorporated by reference, can be used to effect forensic marking at the authenticated viewer's device.

For example, U.S. Pat. No. 8,020,004 describes a technique to enable flexible insertion of forensic watermarks into a digital content signal using a common customization function. The common customization function flexibly employs a range of different marking techniques that are applicable to a wide range of forensic marking schemes. These customization functions are also applicable to pre-processing and post-processing operations that may be necessary for enhancing the security and transparency of the embedded marks, as well as improving the computational efficiency of the marking process. The common customization function supports a well-defined set of operations specific to the task of forensic mark customization that can be carried out with a modest and preferably bounded effort on a wide range of devices. This is accomplished through the use of a generic transformation technique for use as a “customization” step for producing versions of content forensically marked with any of a multiplicity of mark messages.

Another example watermarking technique is described in U.S. Pat. No. 6,912,315, where auxiliary information representing binary or multi-level logical values is embedded into successive segments of an audio content, video content or other content in response to a user request to download the content via an on-line distributor on a computer network such as the Internet. To avoid unnecessary delays in providing the content to the user, the content is pre-processed to provide two sets or copies of the content. For example, one set contains segments with an embedded binary “0”, while the other set contains corresponding segments with an embedded binary “1”. Successive segments are selected from one of the two sets to provide a time-multiplexed composite content that includes an embedded binary data sequence that identifies the user. In another example watermarking technique described in U.S. Pat. No. 7,677,282, a first reduced-scale signal is produced which corresponds to the host content embedded with a first logical value and a second reduced-scale signal corresponding to the host content embedded with a second logical value is also produced. A first set of segments from the first reduced-scale signal my be combined with a second set of segments from the second reduced-scale signal in a pre-defined manner to produce a composite embedded host content. Thus, this technique, reduces the storage and transmission requirements of the watermarking system since only the original content plus two reduced-scale signals are produced and transmitted.

Because client devices are in the possession of authenticated viewers acting as piracy originators, any forensic watermarking operations that they perform may need to be secured against tampering. Techniques may be employed to increase the security of forensic watermarking operations performed in the client device.

A distribution server may generate the forensic watermark locally or it may be generated based, wholly or in-part, on information produced from previous analysis of the program content. In some embodiments, the distribution server produces a watermarked stream by selecting among multiple alternate versions of the program stream (or portions of the program stream) to deliver a content to a particular authenticated user. In some embodiments, the distribution server provides additional program stream data for delivery to an authenticated user that will be combined in a client device to produce forensically watermarked program data. The distribution er may otherwise modify the broadcast stream that is delivered to an authenticated user to forensically watermark the data.

Forensic watermarking may be performed on compressed audio or video content or on uncompressed audio or video content. Applicable techniques in the known arts include U.S. Pat. Nos. 6,430,301 and 8,259,938, which are herein incorporated by reference in their entirety.

For example, U.S. Pat. No. 6,430,301 describes a system for embedding digital watermarks, where different copies of content, such as audio data, are formed with a common watermark (CW) and different transaction watermarks (TW). The CWs are provided in time-aligned intervals of the different copies of the content. Based on a user transaction request, portions of the different copies of the content are assembled by selectively splicing the different copies together at the CW locations to provide a copy with a unique sequence of TWs associated with the user.

In another example, described in U.S. Pat. No. 8,259,938, forensic marks are embedded in a host content that is in compressed domain. In particular, the host content is preprocessed to provide a plurality of host content versions with different embedded watermarks that are subsequently compressed to form a plurality of tributaries. A host content may then be efficiently marked with forensic marks in response to a request for such content. For example, a code is generated in accordance with the metadata, a plurality of content segments from the plurality of such tributaries that are in compressed domain are selected based on that code. The selected tributary segments are then assembled to produce a forensically marked host content in compressed domain. The marking process is conducted in compressed domain, thus reducing the computational burden of decompressing and re-compressing the content, and avoiding further perceptual degradation of the host content.

The forensic watermark that is embedded in an authenticated viewer's viewed broadcast stream may be associated to the authenticated viewer in any of a number of ways. It may comprise, or correspond to, an identifier of the account that is established to identify the viewer as a customer or the broadcast distribution service, such as a subscriber account number, user identification code, email address, a username, or other similar identifier. Alternatively, or additionally, it may be an identifier of a specific commercial or electronic transaction between the authorized distributor and the authenticated viewer, such as a transaction confirmation number, a transaction identification number, or other similar identifier. Alternatively, or additionally, it may be an identifier associated with a device or media associated with the authenticated user, such as an electronic serial number, a device identifier, a security key, a device certificate, a credential identifier, or other similar identifier. Alternatively, or additionally, it may be an automatically generated value, such as a watermark serial number, a unique device/timestamp pair, or a statistically-unique randomly generated value, a Tardos code, or similarly determined value, that is associated in a database with a data value associated with the authenticated viewer. When, for example, a random number is used for associating the receive device (or its user) to the content, the identity of the receiver device or the user of the receiver device is not divulged to the general public. Additionally, the forensic watermark may be an encrypted, scrambled or otherwise encoded version of any of the aforementioned data values.

In addition to associating the forensic watermark with an authenticated user, the forensic watermark may also be associated with the identity of the broadcast content (e.g. “UFC 157—USA”, “UFC 158—UK”), the identity of the authorized distributor (e.g. “UFC.com”, “Time Warner Cable Southern California”), the identity of the client (e.g. “HLS—Safari”, “Xbox 360 xFinity App”), and/or some other identifier which may be employed for the purpose of identifying the content, detection of the forensic watermark, and/or associating the forensic watermark with an authenticated viewer.

The forensic watermark may incorporate integrity verification techniques for the purpose of reducing the likelihood of false or erroneous detection and/or to provide protection against attempts at modification or forgery. Such integrity verification techniques may include the use of error correction and detection codes, the use of a one-time identifier, the sparse selection of the watermark from a very (e.g. exponentially) large vector space of possible identifiers, the use of a cryptographic signature, a cryptographic hash, a time-varying value, and/or a randomly selected value.

When a semi-blind forensic watermarking technique is employed, a part of the forensic watermark embedding process includes the production of side information that is used in the forensic watermark detection process. The side information may be produced in conjunction with an analysis of the broadcast stream content, which is often a first stage of modification of the broadcast stream which prepares the broadcast stream for a later stage of forensic watermark embedding. Alternatively, or additionally, the side information may be produced through the complete embedding of the forensic watermark into the broadcast stream. In any case, it is necessary that this detection side information be made available for detection of the forensic watermark. Any of a variety of arrangements may be employed for this purpose. In one embodiment, the detection side information is transmitted directly from a device that is performing forensic watermark embedding functions to another device that is performing forensic watermark detection functions. In another exemplary embodiment, the detection side information is transmitted by a device that is performing forensic watermark embedding functions to a central storage location (such as a web service) from which a device that is performing forensic watermark detection functions may request and retrieve it. Such an arrangement where a central authority facilitates the dissemination of the side information is particularly useful when either forensic watermark embedding or detection is being performed by more than one party or device for the same broadcast content, because the central storage location can avoid the need for redundant coordination and communications between the multiple embedding and/or detection devices.

In some embodiments, the semi-blind detection is performed in an environment where the original broadcast signal is available and a non-blind watermarking technique could alternately, or additionally, be employed (e.g. an arrangement where the original broadcast signal is transmitted to the location where forensic watermark detection is performed and the detection side information is derived at that location in conjunction with forensic watermark detection or, alternately, the placement of forensic watermark detection at the same location where forensic watermark embedding is performed). When a semi-blind watermarking technique is employed, the detection side information can be made available to the forensic watermark detection function in real-time (pr substantially real time) so that the forensic watermark detection is completed during the broadcast so as to enable a real-time anti-piracy action to be initiated.

In addition to forensic watermarking for the purpose of identifying an authenticated viewer, it may also be desirable to employ additional watermarking apart from the forensic watermark that permits identification of the broadcast stream itself, the authorized distributor of the broadcast stream, the transmission channel and/or transmission technique of the broadcast stream (e.g. web streaming to browser, IP delivery to OTT client, distribution over cable plant, distribution over satellite network), etc. The additional watermarks can also communicate the copyright status, protection status, or permitted usage of the broadcast stream. The embedding of such watermark(s) may be performed independently of or in conjunction with the forensic watermark embedding. Such additional watermarks may or may not be imperceptible to the viewer.

Further, it may also be desirable to perform “fingerprint registration” on the broadcast stream (or portions of it) for the purpose of later identifying the broadcast stream via “fingerprint matching.” Fingerprint registration involves analysis of the broadcast stream content via a statistical or other mathematical process in order to produce one or more data values (“fingerprints”) that are descriptive of salient aspects of the content and the storage of those fingerprints in a database. Fingerprint matching is a process for later identification of a broadcast stream by generating fingerprints from the broadcast stream and comparing those fingerprints to previously generated fingerprints stored in the database to determine whether they match within an acceptable margin of error.

It may be the case that a particular piece of broadcast content is distributed via multiple different authorized distributors. It may also be the case that a particular piece of broadcast content is distributed via multiple different distribution avenues, e.g. web streaming to browsers, IP streaming to OTT client software, cable systems, satellite system, etc. It may further be the case that different authorized distributors or distribution avenues employ different technologies for watermarking or fingerprinting the content for identification purposes or employ different technologies for forensically watermark embedding, which are adapted to their business needs or preferences or technical needs or preferences.

Accessing Pirated Streams

Pirate streams (or more generally the “disseminated real-time content” or the disseminated version of the real-time content) may be accessed for purposes of real-time anti-piracy in the same manner that they are accessed by pirate distributors or pirate viewers.

By way of example, a pirate stream may be distributed to pirate viewers over the Internet, using any of a large number of transmission protocols designed for this purpose. This may include delivery of the pirate stream from a streaming media server to a client application (such as a web browser, web browser plug-in, or other client) using HTML5, HTTP Live Streaming (HLS), Adobe Flash, Microsoft Siiverlight, RTMP, and/or the like. Alternatively, it may include the delivery of the stream via a live peer-to-peer protocol such as BitTorrent Live, P2P Streaming Protocol (PPSP), or an alternative means.

In some scenarios, access to a pirate stream may be limited to only a limited group of pirate viewers by encryption or an authentication mechanism, similar to an authentication mechanism which may be employed for authenticated viewers of authorized broadcast streams. Such limitations may be for the purpose of masking the activities of the pirate distributor or viewers or may exist to allow the pirate distributor to profit from their activities, for example, by charging pirate viewers a fee for access as an authorized distributor might. But a pirate stream can only represent a meaningful threat to the market for the legitimate broadcast if it is accessible to significant numbers of would-be legitimate viewers as a substitute for the authorized broadcasts. Therefore, in most practical cases, pirate streams can be located and accessed in the same manner that a pirate viewer might. For pirate streams distributed over the public Internet, locating a pirate stream can be done by, for example, searching via Web search engine, P2P tracker index, link farms, cyberlockers, by monitoring and participation in discussion boards, chat rooms, or IRC channels, or through the use of dedicated hardware devices or application software that enables location of pirate streams.

Once located, access of the pirated streams may be performed via similar method as the pirate viewer, such as by submitting a request to a web server, participating in a peer-to-peer network protocol, or selecting playback of a channel from a device or application. Selection of the pirated streams, from among those that have been located, may be prioritized based on one or more criteria, including reputation of the source, publicly accessible ratings, stream quality, geographic location of the distributor, popularity of the stream, search rank, previous anti-piracy system results, price of accessing the stream, the economic value to the anti-piracy system operator for responding to detected piracy, the amount of time remaining in the broadcast stream, randomly, and/or the like.

Accessing a stream may also include authenticating as a pirate viewer with a pirate distributor, which may include engaging in a commercial transaction with said distributor, providing authentication credentials, performing an authentication, key exchange or other secure protocol, or an alternative means in order to receive and/or decrypt the pirate stream. It may be performed using techniques to hide the identity of the anti-piracy system from the pirate distributor, such as through the use of a dynamic IP address, a proxy server, anonymization protocol, a one-time use authentication mechanism, a non-traceable and/or anonymous financial instrument. It may include participating in a stream distribution communications protocol. It may include parsing and/or demultiplexing a container format such as any of the MPEG variants, Matroska, AIFF, AVI, Flash and/or QuickTime. It may include decoding audio and/or video content from one or more data-rate reduction encoding formats such as MPEG-2, H.264, H.265, Ogg, MP3, Dolby, and/or DTS, it may include presentation of audio and/or video content for viewing by a real-time anti-piracy system operator. It may include transmission of portions of decoded audio and/or video content via analog or digital transmission techniques for forensic watermark detection.

Once a stream is accessed, it may be desirable to confirm (or determine) the identity of the stream as a pirated stream so as to avoid directing forensic watermark detection resources towards streams that do not contain them. In some embodiments, it may be necessary to identify the stream for purposes of enabling watermark detection, such as in the event that anon-blind or semi-blind forensic watermark technique is employed. Stream identification may be performed via one or more identification techniques such as inspection by an anti-piracy system operator, by direct automated comparison of the received stream with the broadcast stream, by fingerprint matching and/or by detection of content identification watermarks. If identification of the received stream indicates that the accessed stream is not a forensically watermarked broadcast stream, attempts to detect forensic watermark may not be undertaken.

In one example embodiment, an additional watermark is embedded in broadcast streams to signal that such streams will be subject to protection by a real-time anti-piracy system. In some embodiments, such an additional watermark can be detected with greater reliability and/or less cost than the forensic watermark. In such embodiments, it may be beneficial to first detect the additional watermark and establish whether the forensic watermark is likely to be present in advance of attempting to detect the forensic mark. For example, the likelihood of the presence of the forensic watermark may be explicitly indicated in a content identification watermark (e.g., embedded separately from the additional watermarks, or as part of the additional watermark), or it may be obtained using information indicated in the watermark in conjunction with additional information sources (such as might result from a content identification watermark in conjunction with a metadata database). A similar result may be obtained through the use of fingerprint matching for stream identification.

An additional use of broadcast stream identification may be to facilitate semi-blind or non-blind forensic watermark detection. In such cases, forensic watermark detection is dependent on the availability of side-information (the semi-blind case) or an unmarked version of the broadcast stream (non-blind case). Identifying the content permits the required side information and/or unmarked version of the content to be obtained for use in forensic watermark detection from a location where it is generated or stored.

An additional use of broadcast stream identification is to facilitate an action to be taken in the event that forensic watermark detection fails to successfully detect a forensic mark, including the use of an additional watermark to identify the authorized distributor that delivered the pirated stream to the piracy originator. Failure to successfully detect a forensic mark in a pirate stream may provide evidence that the authorized distributor did not embed a forensic watermark in the broadcast stream provided to the authenticated viewer or that the forensic watermark which the authorized distributor embedded was removed or obscured in the content by the piracy originator or a pirate distributor.

When a distinct additional watermark is embedded in the broadcast content provided to one or more individual authorized distributors, the detection of this distinct watermark in pirated streams will identify the authorized distributor responsible for such failure. Such evidence may be employed by the owner or rights holder to take a real-time or subsequent anti-piracy action against the identified authorized distributor. Such action may include: providing notice to the authorized distributor, imposing a financial penalty on the authorized distributor, or imposing or enforcing a contractual requirement on the authorized distributor to embed a forensic watermark or take action to remedy a failure in the forensic watermark technology. Such evidence or notice received may be employed by the identified authorized distributor to take a real-time or subsequent anti-piracy action. Such action may include deploying a forensic watermark technology, modifying a forensic watermark embedding technology to respond to a circumvention, notifying a forensic watermark technology provider of such failure, and/or updating software or firmware in a device in which forensic watermark embedding may have been compromised. While the action in response to the identification of a distributor whose authenticated viewer is the piracy originator may not enable the detected piracy event to be stopped, it may facilitate events that are of value to the owner or rights holder in the content or the distributor and which may facilitate the more effective real-time response to piracy at a later time.

In some embodiments, the operations corresponding to identifying the accessed streams and the detecting of forensic watermarks can be associated, integrated, and/or combined.

When a pirate stream is accessed, it may be accessed only for a limited period of time rather than for the entire duration of the broadcast. For example, access of the pirate stream may cease if the content is affirmed to not be of interest for forensic watermark detection, if the identity of the broadcast stream cannot be established after a period of time, and/or if another pirated stream of greater interest or value is located. Further, continued access to a particular pirate stream may cease based on the outcome of forensic watermark detection efforts. This may be as a result of the successful detection of a forensic watermark (which may make continued access unnecessary, because all information needed to take action has been recovered). Additionally, or alternatively, continued access to a particular pirate stream may cease as a result of a failure to detect the presence of a forensic watermark after a certain period of examination, which may make continued access appear unlikely to produce actionable information. Additionally, or alternatively, continued access to a particular pirate stream may cease as the result of the forensic watermark detector determining that the stream is watermarked but the forensic watermark cannot be fully identified (in which case some alternate activities may be justified, such as locating and accessing a pirate stream of higher quality).

At least some of the steps in the process of locating, accessing, and identifying the pirate streams may be performed manually, automatically, or through a combination of manual and automated processes. In some embodiments, some or all of the process of locating and accessing pirated streams is automated so as to permit large numbers of pirated streams to be rapidly examined in a cost effective manner.

In some example embodiments, in order to locate and access pirate streams distributed over the worldwide web on an automated basis, a computer is programmed to submit requests for a particular string or set of strings related to a live broadcast stream (such as “free UFC live stream”) to a search engine server or other web index server. The received results of such submission may be parsed to identify links that indicate URLs or other indices that may be associated with access to pirated streams. Further, requests may be submitted to access the identified web resources and parse and prioritize the responses until a content stream resource is identified. A request to obtain the content stream resource may then be submitted to a web server, and the content stream accessed. The accessed content stream may be parsed, demultiplexed, and/or decoded to obtain the content stream essence which may be provided to a function, module, or component for content identification. In some embodiments, where a content identification operation is performed, a content is identified as a live broadcast stream which may be embedded with a forensic watermark, all or part of the content stream may be provided to one or more forensic watermark detector. The selection and/or configuration of an appropriate forensic watermark detector may be indicated by information obtained from a content identification watermark associated with a particular authorized distribution path. In some embodiments, where content identification is not performed, any accessed stream may be the subject of forensic watermark detection. Alternatively, the accessed contents may be submitted for forensic watermark detection based on another selection criteria as described above. The systems that are implemented in accordance with the disclosed embodiments can be implemented with the capabilities of being able to locate, access, and/or identify a large number of pirate streams in a parallel and/or serial fashion in a cost effective manner.

Detecting Forensic Watermarks

Audio and/or video content from an accessed pirate stream may be analyzed for the purpose of detecting embedded forensic watermarks which are used to identify the authenticated viewer that is the piracy originator.

In embodiments that support blind watermark detection, the watermark detection is performed on content in the pirate stream to recover forensic watermarks contained within. In embodiments that support semi-blind forensic watermark detection, the requisite side information can be obtained for use in forensic watermark detection. To enable a real-time anti-piracy action on a live broadcast stream, the side information must be obtained in substantially real-time (and/or ahead of the real-time broadcast) from the relevant watermark system component. In embodiments that support non-blind watermark detection, the un-watermarked version of the broadcast stream must be accessed for forensic watermark detection.

The speed and efficiency of effort in detecting forensic watermarks from pirate streams is of considerable importance. To this end, the disclosed embodiments provide for detection of forensic watermarks from a pirate stream from a short segment of the pirate stream after a short period of automated processing of the content of the stream. It may not be necessary to attempt, forensic watermark detection from the entire duration of the pirated stream; only a sufficiently long portion of the content need be analyzed as is required by the forensic watermarking technology to obtain a sufficiently high likelihood for recovery of the embedded forensic watermark.

With some forensic watermarking technologies, it may be advantageous or even necessary to employ a process for aligning or “registering” the content in the pirate stream for forensic watermark detection. For example, if a video content includes temporal and/or spatial deformities compared to the original video (e.g., due to transmission impairments or video processing operations), such a content may need to be processed to undo temporal synchronization issues and/or spatial misalignment issues. Such registration may be automated or may include an interaction by a system operator.

Forensic watermarking detection may include verification of the integrity of the forensic watermark. Alternatively, such integrity verification may be performed subsequently, for example in conjunction with the determining of the association between the forensic watermark and an authenticated user.

Anti-Piracy Actions

Once a forensic watermark is detected from the content of an accessed pirated stream, it may be desirable to store information associated with the pirated stream (such as all or a portion of the pirate stream, descriptive information regarding the time, location and means of location and access to the pirated stream, the forensic watermark, or other associated information including both additional detail or summary information) in a database as evidence of the basis for subsequent anti-piracy actions.

It may be desirable, prior to performing an anti-piracy action, to analyze (either in an automated fashion, by one or more system operators, or with a combination of such methods) all or a part of recorded information associated with the location, access, forensic watermark detection, or the past activities of the authenticated user implicated as the piracy originator in order to ensure that any subsequent action is reasonable and justifiable, in particular if the action is one with adverse consequences for some party, such as the pirate originator or the pirate distributor or which may present a legal or financial liability for a party-involved in carrying out the anti-piracy action. The selected anti-piracy action (or decision to take any action at all) may take into account such information as applies to the specific circumstances indicated through this analysis.

It may also be desirable, prior to performing an anti-piracy action, to perform additional analysis of the content in the accessed pirate stream. Such further analysis may comprise additional forensic watermark detection, additional review or analysis of the content in the pirate stream to confirm its identity, or other analysis for the purpose of confirming that an anti-piracy action is justified.

As described previously, the forensic watermark is associated with a particular authenticated viewer and its presence in a pirate stream constitutes direct evidence that the authenticated viewer is the piracy originator of the accessed pirate stream. This association may be direct, such as cases where the forensic watermark conveys a customer identifier, an identifier associated with a device used by an authenticated viewer to access the broadcast stream, and/or an identifier associated with a particular transaction. The association may also be indirect, in which case it may be necessary to reference information stored in a database to determine the associated authenticated viewer from the detected forensic watermark.

Because the disclosed embodiments permit rapid, accurate identification of an authenticated user acting as a piracy originator, a wide range of anti-piracy actions are available.

In some embodiments, for purposes of minimizing the economic harm resulting from the availability of the pirate stream as a substitute for the legitimate broadcast stream as a commercial product, one or more anti-piracy actions is used to stop or thwart the piracy origination from continuing to occur while the broadcast is still ongoing. Because the systems of the disclosed embodiments allow the authenticated viewer acting as piracy originator to be definitively identified via their association with the detected forensic watermark during the broadcast, an anti-piracy action can be targeted at halting their continued action.

A direct way of achieving this is to restrict the piracy originator's continuing access to the broadcast stream, which can be achieved in any of a number of different ways, as is evident from the following exemplary embodiments. In one exemplary embodiment, credential by which the piracy originator is obtaining access to the broadcast stream is revoked or is invalidated. The manner in which this is performed depends largely on the credentialing system used by the piracy originator's authorized distributor, of which there is substantial variation. In some embodiments, revocation or invalidation of the credential is achieved through one or more of: ceasing to distribute content decryption keys to the piracy originator, distributing a revocation message to the piracy originator, ending a piracy originator's authenticated session, revoking a piracy originator's device credential, modifying a piracy originator's account status, redirecting a piracy originator's session, and/or modifying the broadcast stream provided to the piracy originator. Alternatively, or additionally, access to the entire service can be revoked.

The fact that the broadcast stream provided to the piracy originator is being watched by pirate viewers, these pirate viewers will also see the results of such an anti-piracy action. Thus, it may be advantageous to modify the broadcast stream provided to the piracy originator in such a way as to discourage future pirate viewing by pirate viewers of the stream and/or encourage viewing of content via legitimate distributors by pirate viewers of the stream. Such modifications may include the presentation of information on where and how to obtain legitimate broadcast streams, advertising for legitimate broadcast streams, information about the risks or harmful effects of piracy, and/or the like. It may also be desirable to modify the broadcast stream provided to the piracy originator in such a way as to discourage future piracy origination activity by the pirate originator.

After an anti-piracy action is taken against a pirate originator, it may be desirable to determine that such action has taken effect via continued access of the pirate stream from which the associated forensic watermark was detected. Such determination may be advantageously automated if the action is one which can be easily identified in an automated way. Clearly, if the action includes revoking the credentials of the piracy originator, the pirate stream will no longer contain the broadcast content. In this case, automatic detection of a blank signal or of the content displayed in the case of an unauthenticated viewer may be performed. Alternatively, if the anti-piracy action involved a modification of the broadcast stream, such modification may be detected in an automated way to confirm the efficacy of action.

In the event that the anti-piracy action is determined through such further accessing and analysis of the pirate stream to not have been effective, an escalation procedure may be necessary in order to investigate, determine and/or rectify the failure of the anti-piracy action to take effect. Such procedure may include, but is not limited to, additional detection and analysis of forensic watermarks in the accessed pirate stream, reissuance of credential revocation messages, modification of the forensic watermark embedding and/or detector configuration, modification of the forensic watermark, update of the viewer authentication technology, and/or the like.

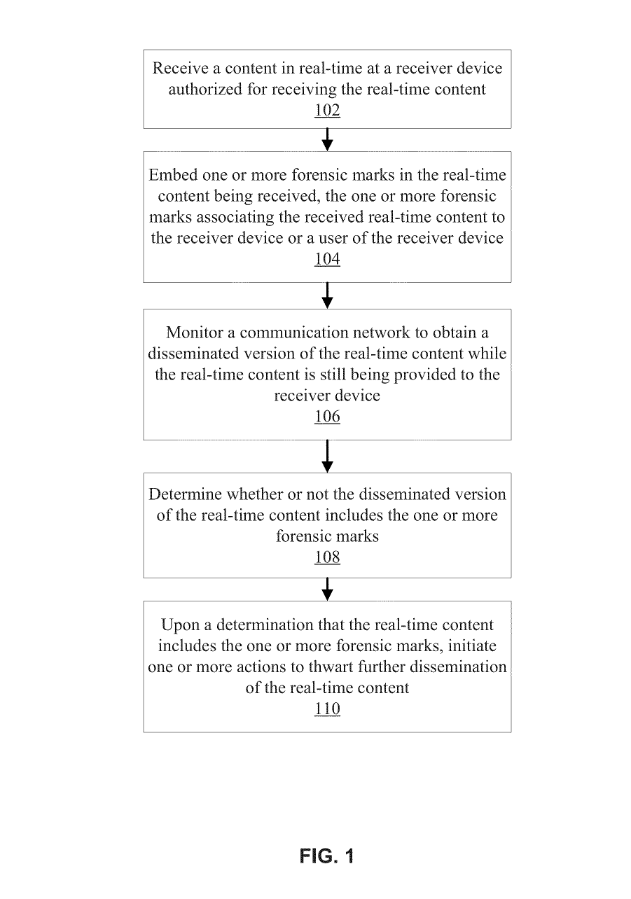

FIG. 1 illustrates a set of operations that can be carried out to thwart unauthorized access to a real-time content in accordance with an exemplary embodiment. At 102, a content in real-time is received at receiver device authorized for receiving the real-time content. At 104, one or more forensic marks are embedded in the real-time content being received. The one or more forensic marks associate the received real-time content to the receiver device or a user of the receiver device. At 106, a communication network is monitored to obtain a disseminated version of the real-time content while the real-time content is still being provided to, or received by, the receiver device. At 108, it is determined whether or not the disseminated version of the real-time content includes the one or more forensic marks. At 110, upon a determination that the real-time content includes the one or more forensic marks, one or more actions is initiated to thwart further dissemination of the real-time content.

In some embodiments, the embedding of forensic marks in the real-time content is carried out prior to the content reaching the receiver device. For example, the embedding of forensic marks can be carried out at the broadcaster and/or the real-time content distributor (or another entity within the broadcast chain prior to delivery of the content to the authorized receiver). In these embodiments, the operations at 104 in FIG. 1 are carried out prior to operations at 102.

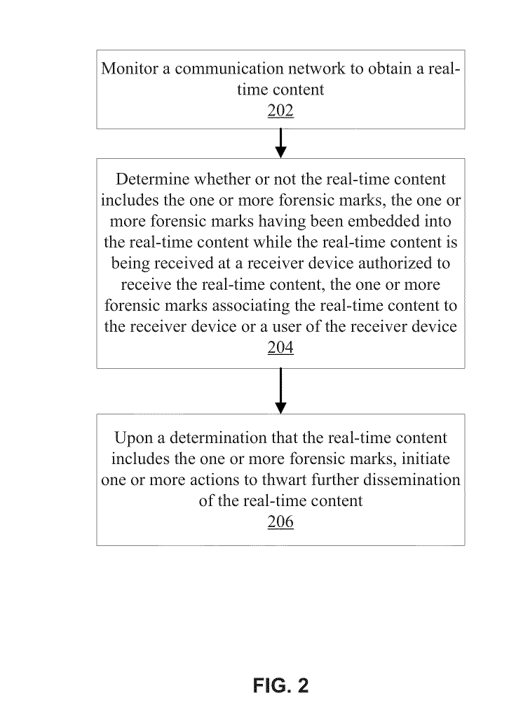

FIG. 2 illustrates a set of operations that can be carried out to thwart unauthorized access to a real-time content in accordance with an exemplary embodiment. At 202, a communication network is monitored to obtain a real-time content. At 204, it is determined as to whether or not the real-time content includes the one or more forensic marks, the one or more forensic marks having been embedded into the real-time content while the real-time content is being received by a receiver device authorized to receive the real-time content. As noted above, in some embodiments, the forensic marks are embedded prior to the reception of the real-time content by the receiver. In such embodiments, the embedding can be carried out at, for example, the real-time distribution center, or at another trusted entity that participates in delivering the real-time content to the receiver. In some embodiments, the one or more forensic marks are embedded at the receiver device. The one or more forensic marks associate the real-time content to the receiver or a user of the receiver device. At 206, upon a determination that the real-time content includes the one or more forensic marks, one or more actions are initiated to thwart further dissemination of the real-time content.

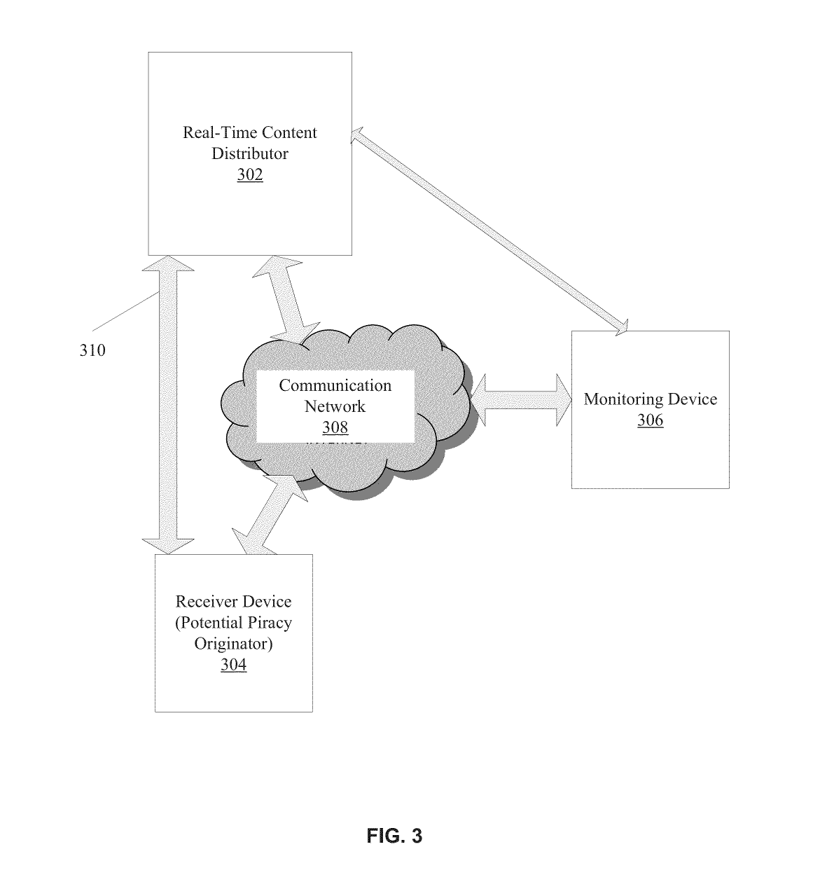

FIG. 3 illustrates a system in accordance with an exemplary embodiment within which various devices and methods for thwarting unauthorized dissemination of real-time content can be implemented. The real-time content is provided from a real-time content distributor 302 to a receiver device 304. The provision of the content can be done directly (e.g., such as from a cable head-end, or from a satellite provider) through a communication channel 310, or indirectly through a communication medium 308, such as the Internet. The receiver device 304, while initially authorized to receive the real-time content, is a potential source of piracy. The monitoring device 306 is configured to monitor the communication network 308 (e.g., various Internet sites, or other communication networks or locations that may be used for dissemination of pirated content). The monitoring occurs while to real-time content is being received by the receiver device 304. Once the monitoring device 306 obtains a real-time content, and determines that it is an unauthorized version of the real-time content that is being received by the receiver device 304, it can issue commands to initiate one or more action to thwart unauthorized distribution of the real-time content. To this end, the monitoring device(s) 306 (e.g., located at one or more monitoring centers) can be in communication with the real-time content distributor 302, or another entity that can communicate with the real-time content distributor 302, or with the receiver device 304.

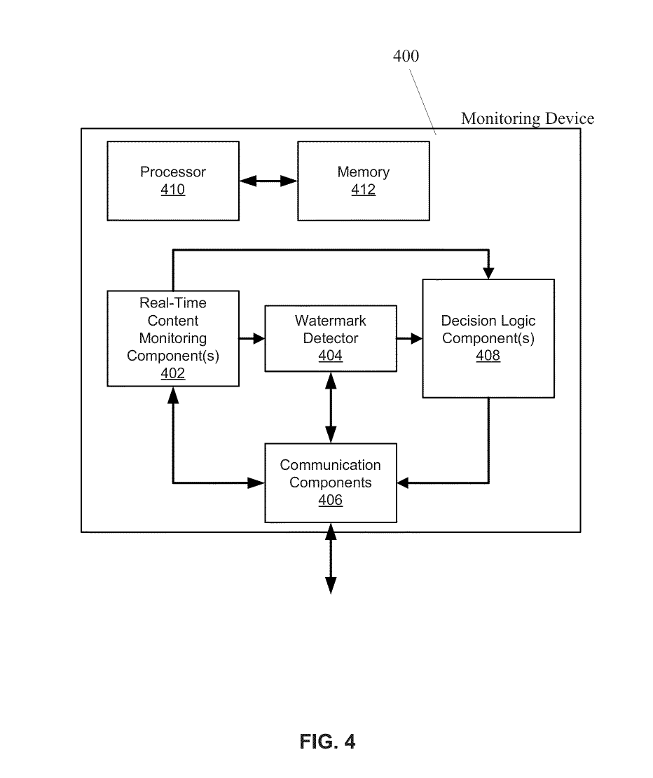

FIG. 4 illustrates a device 400 that is operable to thwart unauthorized dissemination of real-time content in accordance with an exemplary embodiment. The device 400 in FIG. 4 can, for example, be implemented as part of the monitoring device 306 of FIG. 3. The device 400 in FIG. 4 includes a real-time content monitoring components) 402 that is configured to monitor a communication network and search for real-time content that is distributed therein. The watermark detector 404 is coupled to the monitoring component (s) 402 and is configured to detect one or more watermarks (e.g., forensic watermark, identification watermarks, etc.) from the content that is obtained by the monitoring component(s) 402. The communication components 406 are configured to enable communication between the device 400 (and its components) and other entities outside of the device 400. The decision logic component(s) 408 is coupled to the watermark detector 404 and is configured to determine if the detected watermarks justify initiation of further actions. To this end, the decision logic components 408 may be in communication with metadata databases and/or other entities. The decision logic component(s) 408 may also be configured to initiate the one or more actions to thwart unauthorized dissemination of the real-time content, or to allow other components or entities outside of the monitoring device 400 to initiate such actions. The device 400 may also include a processor 410 and a memory 412 coupled to the processor, which may be used to coordinate the operations of the components of the device 400, and/or to include program code for performing at least some of the disclosed operations.

In some embodiments, piracy deterrence and detection techniques may be applied to content streaming over Internet that involves Content Distribution Networks (CDNs) and adaptive bitrate streaming. In adaptive bitrate streaming, user devices, and/or content distribution servers, or CDN edge servers in some cases, detect the user's bandwidth and CPU capacity in real-time and adjust the quality of the stream accordingly. CDN switching (i.e., switching from one CDN to another CDN) allows avoidance of congested CDNs as well as the selection of lower cost CDNs.

Modern content distribution networks (CDNs) comprise large distributed systems of servers deployed in multiple data centers and locations across the Internet. The goal of a CDN is to serve content to end-users with high availability and high performance. For example, the content requests by an end-user are typically algorithmically directed to CDN servers that are close to such user; popular content that have the greatest demand is cached on CDN servers. An exemplary CDN-based streaming process is briefly described as follows.

1) A client manifest, which provides a list of Uniform Resource Identifiers (URIs) for content segments with distinct bitrates are made available to user devices. Such client manifests may also include the URIs for one or more CDNs, as well as the URIs of the files containing encryption keys, segment duration, sequence numbers for each segment, etc. For a pre-recorded content such as VOD distribution, this manifest is typically delivered once at the beginning of the streaming session to all clients. For live content, this manifest may be delivered, periodically or based on availability, to the clients as the new content becomes available for streaming. Similar to the audiovisual content, the client manifest files are often cached on CDN servers.

2) Content publisher servers, where the content is originated, make the streaming content available to CDN servers.

3) After the client (e.g. a software module on the user's device) receives a manifest file, it sends a request to the server, which may be one of the servers specified in the manifest, for a bitrate version of the first segment of the content according to the manifest. Typically the client starts with requesting the content at one of the lower bitrates to avoid excessive delays in a congested network.

4) After the client receives and buffers a content segment, the device starts the playback of the content. At the same time, the client calculates the download time for the previously received segment, determines the appropriate bitrate for subsequent segments, requests subsequent segments, and starts buffering the requested version of the subsequent segments. The client constantly monitors delays in segment delivery and lost packets, and adjusts by switching to a different bit rate, a different edge server, and/or a different CDN.

The above process is repeated until the end of the session has reached. As more content, especially premium content and live content, is available for streaming over the Internet, piracy becomes a growing problem, occurring by means of streaming via user-generated content sites, social networks, peer-to-peer and other proprietary networks, as was described earlier.

In some of the disclosed embodiments, unauthorized dissemination of real-time content is mitigated by identifying the originator of pirated content by naturally and/or forcibly introducing detectable variations in the content instances received by the streaming clients.

Inherent Variations

The originator of the piracy may be identified by observing a pirated stream at a piracy tracking center and identifying the timing of events that may vary from one client to another. For example, interruptions to smooth playback through buffering is common in live event streaming, and those interruptions occur distinctly on different user devices, and can be used to discriminate between them. For example, packets lost in transmission may cause visible or audible artifacts, and also are likely to occur distinctly for distinct clients. Frames may be dropped due to buffering and/or packet loss. Bit-rate switching also produces changes in video quality that may be identifiable from the pirated stream, and the pattern of switches in time is likely to be distinct for distinct users. All of the above events, which may occur naturally in content streaming and distinctly on different user devices, can result in identifiable variations in the pirated content; such variations can be used to trace back the user or the client from which such pirated copy is originated.

The variations introduced by the above events can be automatically detected by, for example, a software program that is executed on a processor (e.g., a microprocessor or controller) even after various processing operations on the pirated content have taken place. Non-limiting examples of such processing operations include transcoding, frame rate and bitrate changes, cropping and resizing, analog capturing and camcording (i.e., capturing a content using a camcorder). For example, the bitrate of a segment in the pirated copy can be detected by measuring the video quality of the segment and the pattern of dropped frames can be detected by identifying missing frames in the pirated copy.

Variations Introduced by Watermarks

The above examples use inherently distinguishable events that vary from one client to another. Other events that aren't inherently distinguishable can be made distinguishable by embedding digital watermarks in distinct copies of the content, as was described earlier in this disclosure. According to some embodiments, variations introduced via watermarking can be used to track the origins of a pirated content. For example, distinct bit rate segments (i.e., segments of a content that is encoded with a particular bit rate) can have embedded distinct watermarks. This is particularly useful when the piracy originator retransmits the pirated content over the Internet at a low bit rate (i.e., at a bit rate that is lower than the bit rate used to deliver the content to the piracy originator), which could mask bitrate switching that naturally occurs at the particular client. In the presence of distinct watermarks for distinct bitrates, bitrate switching becomes easily identifiable from the pirated stream by detecting the distinct watermarks from the segments of the pirated content.

If the bitrate versions are prepared for audio, video and other components of the content separately, different watermarks can be introduced to different components of the content. For example, if audio and video components of a segment are specified in a client manifest separately and each component is encoded into multiple bitrate versions, each component of the segment can be embedded with a different watermark to create variations in the content that is received at the user device.

Furthermore distinct CDNs may have distinct watermarks embedded in the content delivered to them. This way, each event of CDN switching can be identified from the pirated stream based at least in-part on the embedded watermarks associated with each CDN, which allows content received by one user to be distinguished from content received by another user. It is also possible, in some embodiments, to deliver distinctly marked contents to predefined subsets of servers within CDNs. The piracy tracking center needs to be informed about the distribution of marked contents in order to link the selection of content segment source with the watermarks detected in the pirated content.

Such a piracy tracking center can be a single or distributed authority that is tasked with identifying the origins of a pirated content by one or more of piracy originators by analyzing pirated content to discern natural or forced content variations, receiving information related to natural or forced content variations that is produced by another entity, assessing information related to naturally or intentionally introduced variations in various content, receiving and/or accessing log information from user devices, and other operations that are described in this disclosure. In some embodiments, the piracy tracking center identifies one or more piracy originators by analyzing content variations without the feedback channel from user devices or network servers. In embodiments that use the feedback channel, such a feedback channel allows the user devices or network servers to send information regarding the status of content streaming, user devices and/or and networks, in any communications means such as the Internet or 3G/4G, to content distribution servers, piracy tracking centers or a third-party server (e.g., a CDN performance measurement server) during content streaming. This can be achieved if forced content variations are creating a pattern that has one-to-one correspondence to user identification information.

There are many ways to embed watermarks into content segments to introduce detectable variations An exemplary technique is as follows. Each segment of alternating bitrates is embedded with a watermark payload corresponding to a “raw bit” with alternating bit values, e.g., 64 kbps bitrate version is embedded with the bit value ‘0’, 150 kbps bitrate version is embedded with the bit value ‘1’, 240 kbps bitrate version with the bit value ‘0’, 440 kbps bitrate version with the value ‘1’, 640 kbps bitrate version with the value ‘0’, and so on Next, N is selected as the number of “raw bits” per “message symbol”, where “message symbols” employ parity encoding mapping such that the even number of raw bits ‘1’ in the message symbol encodes a message symbol with the value 0, and the odd number of raw bits ‘1’ in the message symbol encodes a message symbol with the value 1.

The streaming client manages embedding of message symbols by using normal bitrate adaptation strategy for the first N−1 segments in a message symbol and selects every N^{th} segment according to the following strategy: 1) determine the bitrate to use based on normal bitrate adaptation strategy; 2) if the selected bitrate results in the message symbol having correct parity for the desired embedded codeword bit, use the selected bitrate; 3) otherwise, use the next lower bitrate.

With the above exemplary approach, there is a 50% probability that every N^{th} segment will be degraded by one bitrate quantum to achieve embedding, but the uniqueness of pirated streams can be guaranteed. In this embodiment, the piracy tracking center doesn't need the feedback channel from the user or the network servers with information about the selection of bitrates by individual clients.

As described earlier, the term fingerprinting may be used to refer to identifying a content based on the content's inherent characteristics. In the context of streaming content, particular fingerprints can result from events which may naturally occur in content streaming, such as bitrate switching, frame dropping or buffering on user devices. For example, if piracy tracing is conducted based on monitoring the spontaneous (or inherent) variations in the received content on user devices in the streaming process (as discussed in the previous section titled “inherent variations”), the piracy tracing may be referred to as being based on a streaming process fingerprint. Such fingerprint may include a distinguishable sequence of events naturally occurring on each client, and result in detectable variations in the received content on each client. However, in cases where the streaming process is actively interfered with in a manner that is substantially imperceptible during normal usage of the streaming content, but can be detected by specially designed extractors, the piracy tracing may be referred to as being based on forensic marking of the streaming process. As described earlier, forensic marking can be effected through embedding of forensic marks into the content. However, forensic marking of the streaming process can also be done without actual watermarking of the content, as also discussed earlier. An example to enable such forensic marking of the streaming process without embedding of actual watermarks is to force certain events (such as bitrate switching, frame dropping or CDN switching) to occur on some clients. Thus, such forensic mark may include a distinguishable sequence of events, at least one of which forcibly occurs on a client, and result in detectable variations in the received content on each client.

Forced Event Occurrence

In some scenarios, the temporal pattern of one or more of the above-noted naturally occurring events is enough to identify the piracy originator. Yet, in some cases naturally occurring events may not be frequent enough to make a quick and reliable discrimination among users, in particular in the case of a collusion piracy. Collusion piracy can occur where two or more distinct streams are combined together to produce the pirated stream. The combining of distinct streams can be done by, for example, averaging the signal from distinct streams or by switching between distinct streams at random or at particular time intervals.

The identification of colluding pirates can be effected deterministically using specially-designed codes. Alternatively, the colluding pirates can be identified probabilistically based on pseudorandom creation of distinguishable events. A common property of both of the above techniques is that each identification technique requires more distinguishable events to identify the colluders compared to the identification of a single piracy originator.

If naturally occurring distinguishable events aren't frequent enough, it is possible to force the creation of additional distinguishable events. For example, the client may be occasionally forced to switch to a bitrate lower than what the transmission bandwidth and/or processing power conditions would dictate, typically for a single segment only. Similarly, switching to a different CDN, which has a differently marked content, can be forced. The forced CDN switching can last for one or more content segments.

Forcing distinguishable events onto users can be done by configuring the clients to carry out the distinguishable event creation (e.g., CDN switching, bitrate switching, etc.) at a rate that may, but does not have to, depend on the rate of naturally occurring distinguishable events. In such a case, it is important to ensure that the client is tamper resistant. The timing of forced creation of distinguishable events can be deterministically selected based on the client identification code or transaction identification code, or it could be pseudo random, provided that the timing of the events is communicated to the servers.

Alternatively, the creation of distinguishable events may be forced by the content delivery servers. For example, the content servers may have two or more copies of the same content segment, each marked by distinct watermarks. A uniquely distinguishable content can be delivered to each particular client as a unique concatenation of the segments of the two or more copies of the same content. The pattern of concatenated content segments can then uniquely identify the delivered content. Additionally, or alternatively, content servers can create client manifests that are distinct for each user and thus guide user selection of content segments by hiding some available options from clients.

Furthermore the forcing of distinguishable events can be done cryptographically. In one embodiment, distinct clients may receive distinct sets of keys which would allow them to decrypt only a subset of content versions and force each client to produce a distinct sequence of distinguishable events. This approach is sometimes referred to as the sequence key technique for broadcast encryption.

Other methods to force distinguishable events may include:

1) Forced bitrate switching: In this technique, the content distribution servers, such as origin servers, make certain content segments available in a first set of bitrates to CDN servers, and make another segments available to CDN servers in a second set of bitrates, which are different from the first set. Such forced bitrate switching can cause different responses by the clients and thus can result in differences in actual playlists. An actual playlist is an instance of client manifest and includes at least the information about the specific bitrate for each segment of the content received by a client. Moreover, the content distribution servers may make the first bitrate set available to some CDN servers and the second set to other CDN servers to make forced bitrate switches.

2) When clients compete for bandwidth, some bitrate adaptation algorithms may randomly select bitrates for these competing clients, thus causing forced bitrate switching events.

3) Variable duration of segments content can be provided to different users, thus increasing the frequency of bitrate switching.

As stated earlier, the sequence of events including at least one such forced event on a client creates a forensic marking of the streaming process. Forcing distinguishable events may have undesirable side effects, as well. For example, forcing the delivery of a lower bitrate segment (even for one segment) may result in dissatisfaction or objections by users. Similarly, forced CDN switching may cause content delivery delays or increase the cost of the content delivery. Therefore it is desirable to minimize the number of forced distinguishable events.

One way of minimizing the number of forced distinguishable events is to leverage as much as possible information from unforced (or natural) distinguishable events. This can be achieved by creating the forced events only if the number of unforced distinguishable events is found to be insufficient over predefined time interval. Further, if there are opportunities to select amongst different forced events, the selection is done in such a way to minimize the side effects as described above. For example, switching CDNs may be preferred over switching to lower bitrates.

In the case of live event streaming piracy, forcing of distinguishable events could be controlled from the piracy tracking center. For instance, after monitoring the piracy stream for a predefined period of time, the piracy tracking center can narrow down the list of possible piracy originators (“suspect users”), and trigger forced event generation only for such suspect users, and not for all of users of the content. Such suspect users are identified by matching distinct characteristics detected from the pirated content with the information regarding the status and events that may cause such distinct characteristics on different user devices or networks, as detailed in the sections to follow. For example, only suspect users receive specially-tailored manifests, and/or server-based segment switching is triggered only for suspect users. Similarly, in the case of encryption-guided event forcing, only suspect users may get particular keysets that limit their ability to decrypt the content from certain CDNs or at certain bitrates.

Furthermore, in order to limit the number of forced events, it is desirable to maximize the amount of information that is created (or gained) by each forced event. This can be achieved by, for example, having multiple options for each forced event, and selecting among those options so as to produce forced events that are uniformly distributed. For example, in a forced switching scenario where there are many distinct CDNs, a new CDN is selected randomly with a uniform probability distribution. In the case where the number of forced events is limited to one per N segments, the selection of which segment, among N segments, to be affected by the forced event can carry additional information.

Events Collection and Identification of Piracy Originator

In some embodiments, there is a feedback channel which provides information regarding the pattern (e.g., the timing) of distinguishable events to the piracy tracking center where pirated content is analyzed and matched to the event reports. Such information can, for example, be periodically sent by the client in real-time (e.g., while live streaming of content is taking place) to a server. The server that receives the feedback can be a CDN server or a separate server owned or operated by the content distributor, content owner, or a third party. Such information received at the server may include log information that identifies the actually-streamed bitrate versions for all segments (e.g., the “actual playlist” for all clients which may simply include a list of request URIs that have been sent by the client) and/or information about the client or user, such as client IP address, user name, and/or session/transaction identifiers. Other information can also be collected in real-time for each segment such as 1) the identity of CDN server that delivered the current segment of the content being played or buffered; 2) the actual bitrate of the content being played; 3) the current content playback position and content timecode; 4) the total memory that is being used by the client; 5) the current bandwidth of the client device; 6) the number and timing of buffer under-runs; 7) number and timing of dropped frames in the reporting period; 8) the duration of the reporting period; and 9) any switch of bitrate versions, as well as the reasons for such switches in the reporting period.

In other scenarios, the information about the events can be collected at, and by, the CDN servers and/or content distribution servers.

The information collected about the client status also helps to: 1) measure and improve CDN performance and the quality of services; 2) optimize the bitrate adaptation algorithm in the client; 3) provide analytic information such as user behavior and responses to advertisements; 4) improve user experience (e.g., by switching CDN providers or servers, or by providing new bitrates that are best suitable for a large set of clients).

When a pirated copy is discovered (e.g., on the Internet or unauthorized distribution network), the piracy tracking center first detects the variations of each segment in the pirated copy to create a list of identifiers for versions (e.g., bitrate variations) in the pirated copy. For example, assume that S_{1A}; S_{1B}, S_{1C}, and S_{1D} represent four variable versions A, B, C, D of the first segment S₁ of a content, and there are 100 segments in the pirated copy of the content. Further assume that the variations among S_{1A}, S_{1B}, S_{1C}, and S_{1D} are inherent variations such as different bitrates or artificial variations introduced by watermarking. If the first segment in the pirated copy is identified as the version A, the second segment in the pirated copy as the version D, and so on, until the last (e.g., the 100^{th}) segment as the version C, such list of identifiers can be created as: S_{1A}, S_{2D}, . . . , S_{100C}.

The piracy tracking center then matches such a list detected from the pirated copy with the information collected (e.g., during the live streaming) of the content regarding content variation received by different user devices (e.g., actual “playlists” from clients). If one of the actual playlists matches the list detected from the pirate content, the client is identified as the originator of the piracy. If more than one client is identified, other intelligence information gathered from the clients or from other sources (such as IP addresses of the piracy originator) can be additionally used to allow identification of the culprit devices.

In some embodiments, the feedback channel may not exist, or it may be obstructed by the attacker (e.g. by the piracy originator). In such embodiments, the forced creation of distinguishable events can be used to create recognizable event pattern even without feedback information. For example, the number of events in a predefined time interval, say N segments, can be forced to be even or odd signifying one bit of information. This can be achieved in the client by monitoring natural events and choosing to create or skip a forced event in the last segment in the set. The binary pattern created this way must have a one-to-one correspondence to the client, transaction, or session identification information in order to be able to identify piracy originator.

Referring again to FIG. 3, the real-time content is provided from a real-time content distributor 302 to a receiver device 304 (the receiver is sometimes is referred to as the requesting device). As noted earlier, the provision of the content is typically done through the communication network 308 such as the Internet. It should be noted that the communication network may comprise a plurality of networks and/or channels that allow connectivity between various devices and entities. For example, such a communication network can provide one or more of Internet connectivity, connectivity over a wireless network (e.g., cellular network, WiFi, etc.), connectivity via a cable channel, a satellite channel, or combinations thereof. The receiver device 304, while initially authorized to receive the real-time content, is a potential source of piracy. The monitoring device 306 can be part of a piracy tracking center that is configured to monitor the communication network 308 to perform one or more the following operations: identifying the origins of a pirated content by one or more of analyzing pirated content to discern natural or intentional content variations introduced by natural or forced events, receiving information related to causing such natural or forced content variations that is produced by another entity such as the receiver device 304, assessing information related to naturally or intentionally introduced variations in various content, receiving and/or accessing log information from user devices (e.g., receiver device 304) that describes the natural or forced events, and other operations such as providing information for Content Distributor 302 to measure and optimize the performance of the Communication Network 308. Some or all of the operations of the monitoring device 306 can occur in real-time while the real-time content is being received by the receiver device 304. The monitoring device(s) 306 can be in communication with the content distributor 302 (e.g., content originators, content origin servers, etc.), Communication Networks 308 (e.g., CDNs, edge servers, etc.), user devices 304, and/or other entities. In some cases, there may be a direct communication link 310 between content distributor 302 and receiver devices 304.

As noted earlier, for purposes of minimizing the economic harm resulting from the availability of the pirate stream as a substitute for the legitimate broadcast stream as a commercial product, one or more anti-piracy actions is used to stop or thwart the piracy origination from continuing to occur while the real-time content playback is still ongoing. For example, the piracy originator's continuing access to the real-time stream can be halted, or alternatively, restricted in a number of different ways, as is evident from the following exemplary embodiments. In one exemplary embodiment, credential by which the piracy originator is obtaining access to the broadcast stream is revoked or is invalidated. The manner in which this is performed depends largely on the credentialing system used by the piracy originator's authorized distributor, of which there is substantial variation. In some embodiments, revocation or invalidation of the credential is achieved through one or more of ceasing to distribute content decryption keys to the piracy originator, distributing revocation message to the piracy originator, ending a piracy originator's authenticated session, revoking a piracy originator's device credential, modifying a piracy originator's account status, redirecting a piracy originator's session, and/or modifying the broadcast stream provided to the piracy originator. Alternatively, or additionally, access of the culprit device(s) and/or users to the entire service can be revoked.

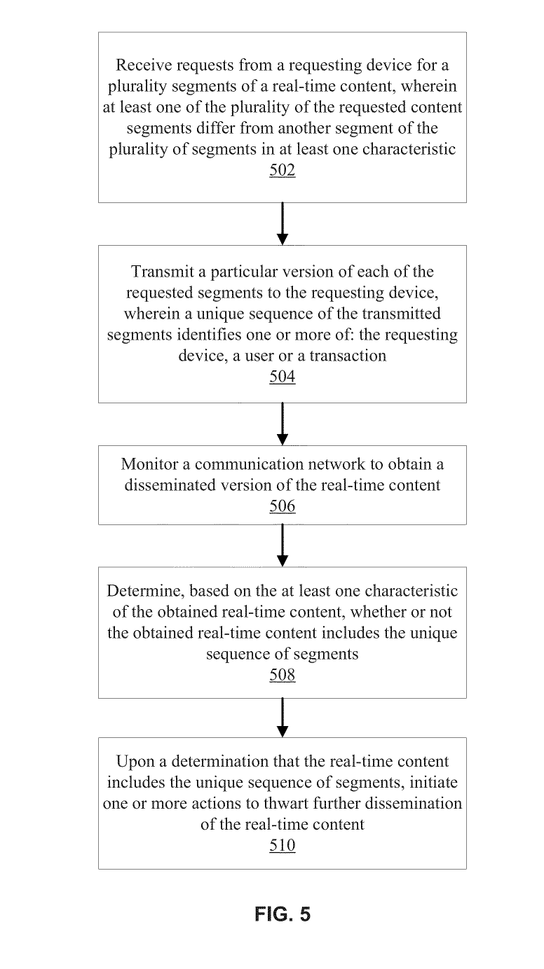

FIG. 5 illustrates a set of operations that may be carried out to thwart unauthorized access to a real-time content in accordance with another exemplary embodiment. The operations that are described in FIG. 5 can be carried out at least in-part at, for example, a piracy tracking center, and/or by a monitoring device. At 502, one or more requests from a requesting device for a plurality segments of a real-time content is received, where at least one of the plurality of the requested content segments differ from another segment of the plurality of segments in at least one characteristic. At 504, a particular version of each of the requested segments is transmitted to the requesting device, where a unique sequence of the transmitted segments identifies one or more of: the requesting device, a user or a transaction. At 506, a communication network is monitored to obtain a disseminated version of the real-time content. At 508, it is determined, based on the at least one characteristic of the obtained real-time content, whether or not the obtained real-time content includes the unique sequence of segments, and at 510, upon a determination that the real-time content includes the unique sequence of segments, one or more actions to thwart further dissemination of the real-time content is initiated.

In an exemplary embodiment, the at least one characteristic is one or more of the following: a bitrate that is used to encode one or more of the plurality of content segments, an imperceptible watermark that is embedded into one or more of the plurality of content segments, a video quality of one or more of the plurality of content segments, an audio quality of one or more of the plurality of content segments, or a dropped frame of one or more of the plurality of content segments. In another exemplary embodiment, determining, based on the at least one characteristic of the obtained real-time content, whether or not the obtained real-time content includes the unique sequence of segments includes identifying variations in the at least one characteristic using one or more segments of the obtained real-time content. For example, identifying the variations can be carried out at least in-part by using a log file associated with the requesting device. The log file can be received from the requesting device. In some scenarios, the log file is transmitted by the requesting device to one or more of: a distribution server, a content distribution network server, or a third-party server. The log file can also be generated at one or more of: a piracy tracking center or a content, distribution network.

In some exemplary embodiments, the log file includes one or more of the following: identities of CDN servers that delivered segments of the real-time content, actual bitrate of real-time content segment as played by the requesting device, a current content playback position and content timecode, an amount of memory that is being used by the requesting device, current bandwidth of the requesting device, a number of buffer under-runs at the requesting device, a number of dropped frames in a reporting period, a duration of a reporting period, or each instance of switching of bitrates (and reasons for such switches).

In another exemplary embodiment, determining, based on the at least one characteristic of the obtained real-time content, whether or not the obtained real-time content includes the unique sequence of segments includes: (a) detecting variations in a plurality of segments of the obtained real-time content, (b) constructing a list of identifiers from the detected variations for the obtained real-time content, and (c) comparing the constructed list of identifiers to a plurality of lists of identifiers to obtain a match. In particular, the plurality of lists of identifiers can be stored on a storage medium, where each of the plurality of the lists corresponds to an instance of a particular real-time content provided to a particular device.

In one exemplary embodiment, the variations in the at least one characteristic include inherent variations produced as part of obtaining the real-time content at the requesting device. In particular, such inherent variations can include one or more of: a variation in a bitrate used to encode a segment of the obtained real-time content, a variation of a number and location of errors in the obtained real-time content, a variation in quality of the obtained real-time content, a variation in transitions among two or more segments of the obtained real-time content, a variation in transition among two or more frames of the obtained real-time content, or a variation in the number of frames in the obtained real-time content.

In some embodiments, the variations include intentionally-introduced variations. In particular, such intentionally-introduced variations can be produced at least in-part by transmitting at least a first segment of the requested segments that is encoded at a first bitrate, and transmitting at least a second segment of the requested segments that is encoded at a second bitrate. In another exemplary embodiment, such intentionally-introduced variations are produced at least in-part by transmitting at least a first segment of the requested segments that is embedded with a first watermark value, and transmitting at least a second segment of the requested segments that is embedded with a second watermark value. In still another exemplary embodiment, the intentionally-introduced variations are produced by at least in-part by transmitting at least a first segment of the requested segments from a first content distribution network (CDN), and transmitting at least a second segment of the requested segments from a second CDN. In another exemplary embodiment, the intentionally-introduced variations can be produced at least in-part by transmitting at least a first segment of the requested segments with a first duration, and transmitting at least a second segment of the requested segments with a second duration.

In yet another exemplary embodiment, such intentionally-introduced variations are produced at least in-part by transmitting at least a first segment of the requested segments that has a first perceptual quality, and transmitting at least a second segment of the requested segments that has a second perceptual quality that is different from the first perceptual quality. In particular, the at least first segment is one of N consecutive segments that are transmitted to the requesting device, where N≧2, and the identifying is carried out at least in-part by determining the position of the first segment amongst the N consecutive segments.

In another exemplary embodiment, the variations in the at least one characteristic include both inherent variations produced as part of obtaining the real-time content at the requesting device and intentionally-introduced variations.

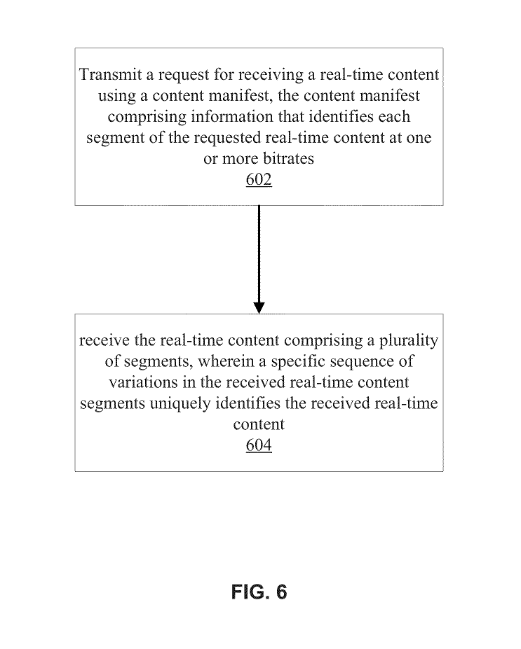

FIG. 6 illustrates a set of exemplary operations that may be carried out to receive a real-time content that allows subsequent actions to thwart unauthorized access to the real-time content. The operations that are illustrated in FIG. 6 may be carried out at, for example, a user device such as cable set-top box, a satellite receiver box, a television set, smart phone, a game counsel, a tablet and/or the like. At 602, a request for receiving a real-time content using a content manifest is transmitted. Such a content manifest can include information that identifies each segment of the requested real-time content at one or more bitrates. At 604, the real-time content comprising a plurality of segments is received such that a specific sequence of variations in the received real-time content segments uniquely identifies the received real-time content.

In one exemplary embodiment, the request includes an initial request for obtaining a first segment of the real-time content that is encoded at a first bitrate. In such an exemplary embodiment, upon reception of the first segment, it is determined, at least in-part based on a download time of the first segment, a second bitrate for a second segment of the real-time content, and a subsequent request for obtaining the second segment at the second bitrate is produced. In another exemplary embodiment, the manifest further comprises information that identifies one or more content distribution networks (CDNs).

Referring again to FIG. 4, which shows a monitoring device that can be implemented at, for example, a piracy tracking center, the real time content monitoring components 402 can analyze the real-time content in order to identify variations in the real-time content that can help identify one or more of: the real-time content, the user device that originally received the content, the transaction that resulted in original transmission of the real-time content to a user device, or a user that requested the real-time content. As noted earlier, such variations can be determined based on changes in content segment bit rates, errors in content segments, perceptual quality, watermarks embedded in the real-time content segments, and the like. As previously described, the communication components are configured to enable communication between the device (and its components) and other entities outside of the device 400, and as such they can include, or be in communication with the appropriate transmitter and receiver circuitry (e.g., antenna, analog and digital components, etc.) that are needed to carry out wired or wireless transmission of signals. The decision logic components 408 in FIG. 4 are further configured to determine if the detected variations can be mapped (or matched) to a pre-stored list of variations that identifies one or more of: the real-time content, the user device that originally received the content, the transaction that resulted in original transmission of the real-time content to a user device, or a user that requested the real-time content. To this end, the decision logic components may be in communication with metadata databases and/or other entities (not shown). The processor 410 and the associated programs stored in memory 412 can be used, for example, to coordinate the operations of other components within the monitoring device, initiate transfer of information and data from/to the monitoring device, perform computations and the like.

In one example embodiment, a device includes a receiver to receive requests from a requesting device for a plurality segments of a real-time content, where at least one of the plurality of the requested content segments differ from another segment of the plurality of segments in at least one characteristic. The device also includes a transmitter to transmit a particular version of each of the requested segments to the requesting device, where a unique sequence of the transmitted segments identifies one or more of: the requesting device, a user or a transaction. Such a device also includes a processor component implemented at least partially in hardware and configured to monitor a communication network to obtain a disseminated version of the real-time content, determine, based on the at least one characteristic of the obtained real-time content, whether or not the obtained real-time content includes the unique sequence of segments, and upon a determination that the real-time content includes the unique sequence of segments, initiate one or more actions to thwart further dissemination of the real-time content. Further, the components of such a device can conduct any one, or combinations of, the disclosed operations.

In another exemplary embodiment, a device can include a transmitter to transmit a request for receiving real-time content using a content manifest, where the content manifest comprising information that identifies each segment of the requested real-time content at one or more bitrates. The device also includes a receiver to receive the real-time content comprising a plurality of segments, where a specific sequence of variations in the received real-time content segments uniquely identities the received real-time content. Such a device also includes a processor component implemented at least partially in hardware to: produce a request for a first segment of the real-time content that is encoded at a first bitrate, upon reception of the first segment by the receiver and based, at least in-part, on a download time of the first segment, determine a second bitrate for a second segment of the real-time content, and produce a request for obtaining the second segment at the second bitrate.

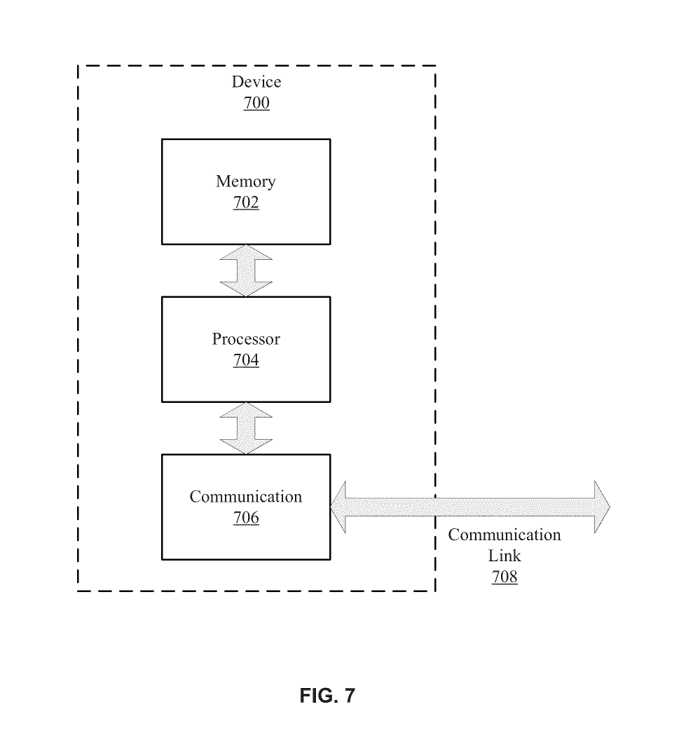

Certain aspects of the disclosed embodiments can be implemented as a device that includes a processor, and a memory comprising processor executable code. The processor executable code, when executed by the processor, configures the device to perform any one of and/or all operations that are described in the present application. For example, FIG. 7 illustrates a block diagram of a device 700 within which various disclosed embodiments may be implemented. The device 700 comprises at least one processor 704 and/or controller, at least one memory 702 unit that is in communication with the processor 704, and at least one communication unit 706 that enables the exchange of data and information, directly or indirectly, through the communication link 708 with other entities, devices, databases and networks. The communication unit 706 may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. The exemplary device 700 of FIG. 7 may be integrated as part of the receiver device 304 that is depicted in FIG. 3 or as part of the monitoring device 306 that is depicted in FIG. 3 or in FIG. 4.

For example, in one embodiment a device can include a processor and a memory that includes processor executable code. The processor executable code, when executed by the processor configures the device to: receive requests from a requesting device for a plurality segments of a real-time content, where at least one of the plurality of the requested content segments differ from another segment of the plurality of segments in at least one characteristic, transmit a particular version of each of the requested segments to the requesting device, where a unique sequence of the transmitted segments identities one or more of: the requesting device, a user or a transaction, monitor a communication network to obtain a disseminated version of the real-time content, determine, based on the at least one characteristic of the obtained real-time content, whether or not the obtained real-time content includes the unique sequence of segments, and upon a determination that the real-time content includes the unique sequence of segments, initiate one or more actions to thwart further dissemination of the real-time content. Further, processor executable code, when executed by the processor can configure the device to carry out any one, or combinations, of the operations that are described herein.

In another exemplary embodiment, a device can include a processor and a memory that includes processor executable code. The processor executable code, when executed by the processor configures the device to: transmit a request for receiving a real-time content using a content manifest, where the content manifest comprising information that identifies each segment of the requested real-time content at one or more bitrates, and receive the real-time content comprising a plurality of segments, where a specific sequence of variations in the received real-time content segments uniquely identifies the received real-time content.

As shown in, for example, FIG. 4 of the present application, the described systems include various components or modules can be implemented as hardware, software, or combinations thereof. For example, a hardware implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

For example, a computer program product, embodied on one or more non-transitory computer readable media, can include program code for receiving requests from a requesting device for a plurality segments of a real-time content, where at least one of the plurality of the requested content segments differ from another segment of the plurality of segments in at least one characteristic, as well as program code for transmitting a particular version of each of the requested segments to the requesting device, where a unique sequence of the transmitted segments identifies one or more of; the requesting device, a user or a transaction. The computer program product can also include program code for monitoring a communication network to obtain a disseminated version of the real-time content, program code for determining, based on the at least one characteristic of the obtained real-time content, whether or not the obtained real-time content includes the unique sequence of segments, and program code for, upon a determination that the real-time content includes the unique sequence of segments, initiating one or more actions to thwart further dissemination of the real-time content. Further, the a computer program product can include program code for performing any one, or combinations, of the operations that are described herein.

In another exemplary embodiment, a computer program product, embodied on one or more non-transitory computer readable media, can include program code for transmitting a request for receiving a real-time content using a content manifest. The content manifest can include information that identifies each segment of the requested real-time content at one or more bitrates. Such a computer program product can also include program code for receiving the real-time content comprising a plurality of segments, where a specific sequence of variations in the received real-time content segments uniquely identifies the received real-time content.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and their practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method for thwarting unauthorized access to a content, comprising:
receiving requests from a requesting device for a plurality segments of a real-time content, wherein at least one of the plurality of the requested content segments differs from another segment of the plurality of segments in at least one characteristic;
transmitting a particular version of each of the requested segments to the requesting device, wherein a unique sequence of the transmitted segments identifies one or more of: the requesting device, a user or a transaction;
monitoring a communication network to obtain a disseminated version of the real-time content;
determining, based on the at least one characteristic of the obtained real-time content, whether or not the obtained real-time content includes the unique sequence of segments; and
upon a determination that the real-time content includes the unique sequence of segments, initiating one or more actions to thwart further dissemination of the real-time content.

2. The method of claim 1, wherein the at least one characteristic is one or more of the following:
a bitrate that is used to encode one or more of plurality of content segments;
an imperceptible watermark that is embedded into one or more of the plurality of content segments;
a video quality of one or more of the plurality of content segments;
an audio quality of one or more of the plurality of content segments; or
a dropped frame of one or more of the plurality of content segments.

3. The method of claim 1, wherein determining, based on the at least one characteristic of the obtained real-time content, whether or not the obtained real-time content includes the unique sequence of segments comprises:
identifying variations in the at least one characteristic using one or more segments of the obtained real-time content.

4. The method of claim 3, wherein identifying the variations is carried out at least in-part by using a log file associated with the requesting device.

5. The method of claim 4, wherein the log file is received from the requesting device.

6. The method of claim 4, wherein the log file is transmitted by the requesting device to one or more of: a distribution server, a content distribution network server, or a third-party server.

7. The method of claim 4, wherein the log file is generated at one or more of: a piracy tracking center or a content distribution network.

8. The method of claim 3, wherein the variations comprise inherent variations produced as part of obtaining the real-time content at the requesting device.

9. The method of claim 8, wherein the inherent variations comprise one or more of:
a variation in a bitrate used to encode a segment of the obtained real-time content;
a variation of a number and location of errors in the obtained real-time content; or
a variation in quality of the obtained real-time content.

10. The method of claim 8, wherein the inherent variations comprise one or more of:
a variation in transitions among two or more segments of the obtained real-time content;
a variation in transition among two or more frames of the obtained real-time content; or
a variation in the number of frames in the obtained real-time content.

11. The method of claim 3, wherein the variations comprise intentionally-introduced variations.

12. The method of claim 11, wherein the intentionally-introduced variations are produced at least in-part by one or more of:
transmitting at least a first segment of the requested segments that is encoded at a first bitrate, and transmitting at least a second segment of the requested segments that is encoded at a second bitrate;
transmitting at least a first segment of the requested segments from a first content distribution network (CDN), and transmitting at least a second segment of the requested segments from a second CDN; or
transmitting at least a first segment of the requested segments with a first duration, and transmitting at least a second segment of the requested segments with a second duration.

13. The method of claim 11, wherein the intentionally-introduced variations are produced at least in-part by transmitting at least a first segment of the requested segments that is embedded with a first watermark value, and transmitting at least a second segment of the requested segments that is embedded with a second watermark value.

14. The method of claim 11, wherein the intentionally-introduced variations are produced at least in-part by transmitting at least a first segment of the requested segments that has a first perceptual quality, and transmitting at least a second segment of the requested segments that has a second perceptual quality that is different from the first perceptual quality.

15. The method of claim 14, wherein the at least first segment is one N consecutive segments that are transmitted to the requesting device, where N≧2, and wherein the identifying is carried out at least in-part by determining the position of the first segment amongst the N consecutive segments.

16. The method of claim 3, wherein the variations comprise both inherent variations produced as part of obtaining the real-time content at the requesting device and intentionally-introduced variations.

17. The method of claim 4, wherein the log file comprises one or more of the following:
identities of content distribution network (CDN) servers that delivered segments of the real-time content;
actual bitrate of real-time content segment as played by the requesting device;
a current content playback position and content timecode;
memory that is being used by the requesting device;
current bandwidth of the requesting device;
a number of buffer under-runs at the requesting device;
a number of dropped frames in a reporting period;
a duration of a reporting period; or
each instance of switching of bitrates, and reasons for such switches.

18. The method of claim 1, wherein determining, based on the at least one characteristic of the obtained real-time content, whether or not the obtained real-time content includes the unique sequence of segments comprises:
detecting variations in a plurality of segments of the obtained real-time content;
constructing a list of identifiers from the detected variations for the obtained real-time content; and
comparing the constricted list of identifiers to a plurality of lists of identifiers to obtain a match.

19. The method of claim 18, wherein the plurality of lists of identifiers are stored on a storage medium, and each of the plurality of the lists corresponds to an instance of a particular real-time content provided to a particular device.

20. A device, comprising:
a processor; and
a memory comprising processor executable code, the processor executable code, when executed by the processor configures the device to:
receive requests from a requesting device for a plurality segments of a real-time content, wherein at least one of the plurality of the requested content segments differs from another segment of the plurality of segments in at least one characteristic;
transmit a particular version of each of the requested segments to the requesting device, wherein a unique sequence of the transmitted segments identifies one or more of: the requesting device, a user or a transaction;
monitor a communication network to obtain a disseminated version of the real-time content;
determine, based on the at least one characteristic of the obtained real-time content, whether or not the obtained real-time content includes the unique sequence of segments; and
upon a determination that the real-time content includes the unique sequence of segments, initiate one or more actions to thwart further dissemination of the real-time content.

21. A computer program product, embodied on one or more non-transitory computer readable media, comprising:
program code for receiving requests from a requesting device for a plurality segments of a real-time content, wherein at least one of the plurality of the requested content segments differs from another segment of the plurality of segments in at least one characteristic;
program code for transmitting a particular version of each of the requested segments to the requesting device, wherein a unique sequence of the transmitted segments identifies one or more of: the requesting device, a user or a transaction;
program code for monitoring a communication network to obtain a disseminated version of the real-time content;
program code for determining, based on the at least one characteristic of the obtained real-time content, whether or not the obtained real-time content includes the unique sequence of segments; and
program code for, upon a determination that the real-time content includes the unique sequence of segments, initiating one or more actions to thwart further dissemination of the real-time content.

22. A device, comprising:
a receiver to receive requests from a requesting device for a plurality segments of a real-time content, wherein at least one of the plurality of the requested content segments differs from another segment of the plurality of segments in at least one characteristic;
a transmitter to transmit a particular version of each of the requested segments to the requesting device, wherein a unique sequence of the transmitted segments identifies one or more of: the requesting device, a user or a transaction; and
a processor implemented at least partially in hardware and configured to:
monitor a communication network to obtain a disseminated version of the real-time content;
determine, based on the at least one characteristic of the obtained real-time content, whether or not the obtained real-time content includes the unique sequence of segments, and
upon a determination that the real-time content includes the unique sequence of segments, initiate one or more actions to thwart further dissemination of the real-time content.

23. The device of claim 22, wherein the at least one characteristic is one or more of the following:
a bitrate that is used to encode one or more of the plurality of content segments;
an imperceptible watermark that is embedded into one or more of the plurality of content segments;
a video quality of one or more of the plurality of content segments;
an audio quality of one or more of the plurality of content segments; or
a dropped frame of one or more of the plurality of content segments.

24. The device of claim 22, wherein as part of determination, based on the at least one characteristic of the obtained real-time content, whether or not the obtained real-time content includes the unique sequence of segments, the processor is configured to identify variations in the at least one characteristic using one or more segments of the obtained real-time content.

25. The device of claim 24, wherein the processor is configured to use a log file associated with the requesting device for identification of the variations.

26. The device of claim 25, wherein the log file is received from the requesting device.

27. The device of claim 25, wherein the log file is transmitted by the requesting device to one or more of: a distribution server, a content distribution network server, or a third-party server.

28. The device of claim 25, wherein the log file is generated at one or more of: a piracy tracking center or a content distribution network.

29. The device of claim 24, wherein the variations comprise inherent variations produced as part of obtaining the real-time content at the requesting device.

30. The device of claim 29, wherein the inherent variations comprise one or more of:
variation in a bitrate used to encode a segment of the obtained real-time content;
a variation of a number and location of errors in the obtained real-time content; or
a variation in quality of the obtained real-time content.

31. The device of claim 29, wherein the inherent variations comprise one or more of:
a variation in transitions among two or more segments of the obtained real-time content;
a variation in transition among two or more frames of the obtained real-time content; or
a variation in the number of frames in the obtained real-time content.

32. The device of claim 24, wherein the variations comprise intentionally-introduced variations.

33. The device of claim 32, wherein the intentionally-introduced variations are produced at least in-part due to one or more of:
transmission of at least a first segment of the requested segments that is encoded at a first bitrate, and transmission of at least a second segment of the requested segments that is encoded at a second bitrate;
transmission of at least a first segment of the requested segments from a first content distribution network (CDN), and transmission of at least a second segment of the requested segments from a second CDN; or
transmission of at least a first segment of the requested segments with a first duration, and transmission of at least a second segment of the requested segments with a second duration.

34. The device of claim 32, wherein the intentionally-introduced variations are produced at least in-part due to transmission of at least a first segment of the requested segments that is embedded with a first watermark value, and transmission of at least a second segment of the requested segments that is embedded with a second watermark value.

35. The device of claim 32, wherein the intentionally-introduced variations are produced at least in-part due to transmission of at least a first segment of the requested segments that has a first perceptual quality, and transmission of at least a second segment of the requested segments that has a second perceptual quality that is different from the first perceptual quality.

36. The device of claim 35, wherein the at least first segment is one of N consecutive segments that are transmitted to the requesting device, where N≧2, and wherein the identifying is carried out at least in-part by determining the position of the first segment amongst the N consecutive segments.

37. The device of claim 24, wherein the variations comprise both inherent variations produced as part of obtaining the real-time content at the requesting device and intentionally-introduced variations.

38. The device of claim 25, wherein the log file comprises one or more of the following:
identities of content distribution network (CDN) servers that delivered segments of the real-time content;
actual bitrate of real-time content segment as played by the requesting device;
a current content playback position and content timecode;
memory that is being used by the requesting device;
current bandwidth of the requesting device;
a number of buffer under-runs at the requesting device;
a number of dropped frames in a reporting period;
a duration of a reporting period; or
each instance of switching of bitrates, and reasons for such switches.

39. The device of claim 22, wherein as part of determination, based on the at least one characteristic of the obtained real-time content, whether or not the obtained real-time content includes the unique sequence of segments, the processor is configured to:
detect variations in a plurality of segments of the obtained real-time content;
construct a list of identifiers from the detected variations for the obtained real-time content; and
compare the constructed list of identifiers to a plurality of lists of identifiers to obtain a match.

40. The device of claim 39, wherein the plurality of lists of identifiers are stored on a storage medium, and each of the plurality of the lists corresponds to an instance of a particular real-time content provided to a particular device.

41. A method comprising:
transmitting a request for receiving a real-time content using a content manifest, the content manifest comprising information that identifies each segment of the requested real-time content at one or more bitrates;
receiving the real-time content comprising a plurality of segments, wherein a specific sequence of variations in the received real-time content segments uniquely identifies the received real-time content.

42. The method of claim 41, wherein:
the request comprises an initial request for obtaining a first segment of the real-time content that is encoded at a first bitrate; and
upon reception of the first segment, determining, at least in-part based on a download time of the first segment, a second bitrate for a second segment of the real-time content, and producing a subsequent request for obtaining the second segment at the second bitrate.

43. The method of claim 41, wherein the manifest further comprises information that identifies one or more content distribution networks (CDNs).

44. A device, comprising:
a processor; and
a memory comprising processor executable code, the processor executable code, when executed by the processor configures the device to:
transmit a request for receiving a real-time content using a content manifest, the content manifest comprising information that identifies each segment of the requested real-time content at one or more bitrates; and
receive the real-time content comprising a plurality of segments, wherein a specific sequence of variations in the received real-time content segments uniquely identifies the received real-time content.

45. A computer program product, embodied on one or more non-transitory computer readable media, comprising:
program code for transmitting a request for receiving a real-time content using a content manifest, the content manifest comprising information that identifies each segment of the requested real-time content at one or more bitrates; and
program code for receiving the real-time content comprising a plurality of segments, wherein a specific sequence of variations in the received real-time content segments uniquely identifies the received real-time content.

46. A device, comprising:
a transmitter configured to transmit a request for receiving a real-time content using a content manifest, the content manifest comprising information that identifies each segment of the requested real-time content at one or more bitrates; and
a receiver configured to receive the real-time content comprising a plurality of segments, wherein a specific sequence of variations in the received real-time content segments uniquely identifies the received real-time content; and
a processor component implemented at least partially in hardware configured to:
produce a request for a first segment of the real-time content that is encoded at a first bitrate,
upon reception of the first segment by the receiver and based, at least in-part, on a download time of the first segment, determine a second bitrate for a second segment of the real-time content, and
produce a request for obtaining the second segment at the second bitrate.
